(19) United States
(12) Patent Application Publication
(10) Pub. No.: US 2025/0077831 A1
(43) Pub. Date: Mar. 6, 2025

(54) TRAINING MACHINE LEARNING MODELS FOR AUTOMATED COMPOSITION GENERATION

(71) Applicant: CFA Properties, Inc., Atlanta, GA (US)

(72) Inventors: Andreas Panayiotou, Atlanta, GA (US); Nathaniel McFarland, Mableton, GA (US)

(21) Appl. No.: 18/883,391

(22) Filed: Sep. 12, 2024

Related U.S. Application Data
(63) Continuation of application No. 16/998,583, filed on Aug. 20, 2020.
(60) Provisional application No. 62/889,352, filed on Aug. 20, 2019.

(51) Int. Cl. G06N 3/006; G06K 19/07; G06N 20/00; G10L 13/02

(52) U.S. Cl. CPC G06N 3/006; G06K 19/0723; G06N 20/00; G10L 13/02

(57) ABSTRACT

A process for automated story generation can comprise receiving, via at least one computing device, interaction data associated with an entity and a physical environment. Based on the interaction data, the at least one computing device can determine that at least one event occurred based on the interaction data. The at least one computing device can execute a trained machine learning model on the interaction data to generate an output comprising one or more interests. The at least one computing device can generate a composition comprising an audio element and a visual element based on the output.

### CROSS-REFERENCE TO RELATED APPLICATIONS

This application claims the benefit of and priority to U.S. Patent Application No. 62/889,352, filed Aug. 20, 2019, entitled “SYSTEMS AND METHODS FOR AUTOMATIC CONTENT GENERATION,” which is incorporated herein by reference in its entirety.

### TECHNICAL FIELD

The present systems and methods relate generally to tracking behavior of a subject and automatically generating content based on tracked behavior.

### BACKGROUND

Previous approaches to generating content for a particular subject may fail to adequately customize the content based on interests and other aspects of the subject. For example, previous content generation processes may merely insert the name and other high-level descriptors of a subject into a composition. Such compositions may lack a sufficient degree of personalization that would otherwise provoke the interest of the subject. Other approaches may rely solely on keywords or other parameters manually inputted to the system by a user. Thus, previous systems do not provide the capability to automatically create custom and personalized content based on subject behavior interests. Therefore, there is a long-felt but unresolved need for a system or method for generating customized compositions that leverage data associated with subject behavior and interests.

### BRIEF SUMMARY OF THE DISCLOSURE

Briefly described, and according to one embodiment, aspects of the present disclosure generally relate to systems and methods for tracking and evaluating behavior of a subject and generating content (such as a digital composition or story) based on evaluated behavior. For exemplary and illustrative purposes, the present disclosure describes the present systems and methods in the context of a child. The present disclosure places no limitations on subjects that may be tracked and evaluated according to the present systems and methods.

In various embodiments, the present technology relates to using interaction data associated with a subject in an interactive environment to produce a digital story that aligns with identified interests of the subject. Provided herein are systems and methods for collecting a variety of data associated with a child playing in an interactive environment, analyzing data to identify a child's interests, and generating content (for example, a digital story including visual and audio components) that appeals to identified interests.

In one or more embodiments, the present technology further relates to using data associated with a subject in an interactive environment to, in virtually real-time, produce, update, and display a digital story that aligns with identified interests of the subject and/or is responsive to detected behaviors of the subject. The present systems and methods can include processes for iterative digital storytelling experiences that direct a subject toward specific locations, items (e.g., toys), and/or tasks in a play environment. For example, the present systems and methods can generate, and display to a subject, initial digital content, and the initial digital content can direct the subject to one or more specific locations, items, and/or tasks. The present systems and methods can determine that the subject interacted with the one or more specific locations, items, and/or tasks, and can generate, and display to the subject, secondary digital content that is at least partially based upon the initial digital content and the directed-to locations, items, and/or tasks.

In an exemplary scenario, a child walks into a dinosaur-themed play room. Initially, a projection source in the room displays a scene of a mother pterodactyl and a nest of pterodactyl eggs. Upon entering the room, an RFID source (as described herein) interrogates the child's RFID wristband and a motion sensor (installed within the projection source) detects movement of the child within a predefined proximity of the motion sensor. The motion sensor can cause the system to trigger the projection source to display first digital content including a carnivorous dinosaur stealing the pterodactyl eggs, and the mother pterodactyl requesting assistance of the child in finding the stolen eggs. Because the system can, via the RFID source and wristband, identify the child, the system can retrieve, and modify the initial content to include, a custom avatar of the child. The initial digital content can direct the child to explore the dinosaur-themed play room and find the stolen eggs.

The room can include one or more egg-shaped elements (e.g., objects, surfaces, etc.) that include RFID sources. The child can then explore the room to “find” the eggs by placing their RFID wristband against the eggs (thereby causing interrogation of the wristband by the RFID sources). The present system can determine when the child “finds” a predetermined number of eggs (to increase ease of the task, the room can include a greater number of egg elements compared to a number of eggs included in the display). Upon determining that the child has “found” the predetermined number of eggs, the system can generate secondary digital content and trigger the projection source to display the secondary digital content. Accordingly, the projection source can display a scene of the custom avatar returning the eggs, the eggs hatching, and the mother pterodactyl suggesting they take the newborn pterodactyls to a play area with other dinosaurs, which may, in effect, direct the child to a dinosaur toy area of the room. As described herein, the system can process data collected by the data sources 103 during the child's time in the dinosaur room and can determine one or more interests of the child and one or more metrics and/or insights regarding play behavior of the child. For example, the system can determine that the child is interested in herbivorous dinosaurs, enjoys helping others, and enjoys “scavenger-hunt”-like play experiences. The present system can utilize the determined interests in subsequent content generation processes (as described herein).

According to a first aspect, a process for automated story generation, comprising: A) receiving, via at least one computing device, interaction data associated with an entity and a physical environment; B) determining, via the at least one computing device, that at least one event occurred based on the interaction data; C) executing, via the at least one computing device, a trained machine learning model on the interaction data to generate an output comprising one or more interests; and D) generating, via the at least one computing device, a composition comprising an audio element and a visual element based on the output.

According to a further aspect, the process of the first aspect or any other aspect, wherein generating the composition comprises generating the audio element by: A) generating a script based on the at least one event and the one or more interests; and B) generating, by a computer voice module, the audio element based on the script.

According to a further aspect, the process of the first aspect or any other aspect, wherein generating the composition comprises generating the visual element by: A) retrieving an avatar associated with the entity; B) retrieving at least one predefined illustration associated with the at least one event and the one or more interests; C) generating text elements based on the script; and D) inserting the avatar and the text elements into the at least one predefined illustration.

According to a further aspect, the process of the first aspect or any other aspect, further comprising: A) combining, via the at least one computing device, the audio element and the visual element into the composition; and B) transmitting, via the at least one computing device, the composition to a computing device associated with the entity.

According to a further aspect, the process of the first aspect or any other aspect, wherein the interaction data comprises historical Radio Frequency Identification (RFID) data associated with a particular region of the physical environment.

According to a further aspect, the process of the first aspect or any other aspect, wherein the interaction data comprises historical engagement data associated with an electronic communication.

According to a further aspect, the process of the first aspect or any other aspect, wherein the one or more interests are expressed as one or more category identifiers.

According to a further aspect, the process of the first aspect or any other aspect, wherein the composition is generated based on determining that an RFID device has moved beyond a predetermined range of an interrogator.

According to a second aspect, a system for automated story generation, comprising at least one computing device configured to: A) receive interaction data associated with an entity and a physical environment; B) determine that at least one event occurred based on the interaction data; C) execute a trained machine learning model on the interaction data to generate an output comprising one or more interests; and D) generate a composition comprising an audio element and a visual element based on the output.

According to a further aspect, the system of the second aspect or any other aspect, wherein the at least one computing device is further configured to: A) generate a script based on the at least one event and the one or more interests; and B) generate, by a computer voice module, the audio element based on the script.

According to a further aspect, the system of the second aspect or any other aspect, wherein at least one computing device is further configured to: A) retrieve an avatar associated with the entity; B) retrieve at least one predefined illustration associated with the at least one event and the one or more interests; C) generate text elements based on the script; and D) insert the avatar and the text elements into the at least one predefined illustration, wherein the visual element comprises the at least one predefined illustration, the avatar, and the text elements.

According to a further aspect, the system of the second aspect or any other aspect, wherein the at least one computing device is further configured to: A) combine the audio element and the visual element into the composition; and B) transmit the composition to a computing device associated with the entity.

According to a further aspect, the system of the second aspect or any other aspect, wherein the interaction data comprises historical RFID data associated with a particular region of the physical environment.

According to a further aspect, the system of the second aspect or any other aspect, wherein the one or more interests are expressed as one or more category identifiers.

According to a third aspect, a non-transitory computer-readable medium for training a computer-implemented model having stored thereon computer program code that, when executed on at least one computing device, causes the at least one computing device to: A) receive interaction data associated with an entity and a physical environment; B) determine that at least one event occurred based on the interaction data; C) execute a trained machine learning model on the interaction data to generate an output comprising one or more interests; D) retrieve a composition associated with the entity, the composition comprising an audio element and a visual element; and E) modify the composition based on the output by generating a second audio element and a second visual element.

According to a further aspect, the non-transitory computer-readable medium of the third aspect or any other aspect, wherein the computer program code further causes the at least one computing device to: A) generate a script based on the at least one event and the one or more interests; and B) generate, by a computer voice module, the second audio element based on the script.

According to a further aspect, the non-transitory computer-readable medium of the third aspect or any other aspect, wherein the computer program code further causes the at least one computing device to: A) retrieve an avatar associated with the entity; B) retrieve at least one predefined illustration associated with the at least one event and the one or more interests; C) generate text elements based on the script; and D) insert the avatar and the text elements into the at least one predefined illustration, wherein the second visual element comprises the at least one predefined illustration, the avatar, and the text elements.

According to a further aspect, the non-transitory computer-readable medium of the third aspect or any other aspect, wherein the computer program code further causes the at least one computing device to: A) combine the second audio element and the second visual element into the composition; and B) transmit the composition to a computing device associated with the entity.

According to a further aspect, the non-transitory computer-readable medium of the third aspect or any other aspect, wherein the interaction data comprises historical RFID data associated with a particular region of the physical environment.

According to a further aspect, the non-transitory computer-readable medium of the third aspect or any other aspect, wherein the one or more interests are expressed as one or more category identifiers. These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates an exemplary networked computing environment, according to one embodiment of the present disclosure.

FIG. 2 illustrates an exemplary operational computing architecture, according to one embodiment of the present disclosure.

FIG. 3 illustrates an exemplary aggregated computing architecture, according to one embodiment of the present disclosure.

FIG. 4 illustrates an exemplary content engine architecture, according to one embodiment of the present disclosure.

FIG. 5 illustrates an exemplary communication module architecture, according to one embodiment of the present disclosure.

FIG. 6 is a flowchart of an exemplary data aggregation process, according to one embodiment of the present disclosure.

FIG. 7 is a flowchart of an exemplary data collection and interest identification process, according to one embodiment of the present disclosure.

FIG. 8 is a flowchart of an exemplary content generation process, according to one embodiment of the present disclosure.

FIG. 9 is a flowchart of an exemplary machine learning process, according to one embodiment of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context indicates that such limitation is intended.

### Overview

Aspects of the present disclosure generally relate to tracking behavior of a subject, identifying subject interests, and generating content based on identified interests.

In at least one embodiment, the present disclosure provides systems and methods for monitoring and evaluating behavior from one or more subjects in a particular environment, and, based on behavior evaluations, generating content that includes experiences, items, and activities the one or more subjects may enjoy (e.g., as predicted from identified interests). For illustrative purposes, the present systems and methods are described in the context of an interactive play area and digital stories for children.

Briefly described, the present disclosure provides systems and methods for tracking behavior of a subject in an environment, analyzing tracked behavior to determine or predict interests of the subject, and automatically creating customized digital content that appeals to the determined or predicted subject interests. For illustrative purposes, the present systems and methods are described in the context of children playing in a play area; however, other embodiments directed towards alternate or additional subjects and environments are contemplated.

The present system can include a variety of interaction and engagement techniques that collect information on a subject's (e.g., a child's) behavior in one or more particular regions of a play area. The system can utilize data collection techniques including, but not limited to, radio frequency identification (“RFID”) tracking, computer vision, analysis of subject-generated content, free form inputs (e.g., received by the system from one or more individuals), and online interaction tracking (e.g., via read receipts, cookies, links, etc.). The system may receive data from a variety of sources (e.g., RFID tags, one or more processors, a website, etc.).

The system includes at least one physical environment in which a subject interacts with a variety of items (e.g., toys, screens, electronic devices, etc.), persons, and experiences (e.g., pre-engineered events that occur in response to a specific trigger). In one or more embodiments, the subject may carry and/or wear an RFID tag (for example, in the form of an RFID wristband) that is responsive to interrogations from a plurality of RFID devices (e.g., RFID tags, antennae, etc.) that are located throughout the at least one physical environment. Thus, the one or more physical environments may contain a plurality of electronic devices (referred to as “RFID sources”) that can interrogate and communicate with the RFID wristband. In various embodiments, an RFID source may be responsive to the RFID wristband (and/or other RFID tags not borne by the subject) in one or more scenarios including, but not limited to, the subject (wearing the RFID wristband) moving within a predefined proximity of an RFID source, the subject moving an RFID tag-containing item within a predefined proximity of an RFID source, and the subject moving within a predefined proximity of another subject (e.g., that is also wearing an RFID wristband, or the like).

In various embodiments, an RFID tag of the present system (e.g., whether disposed in a wristband or otherwise) may include a unique RFID identifier that can be associated with a bearer of the RFID tag (e.g., a subject, object, location, etc.). Thus, an RFID tag borne by a subject (e.g., wearing an RFID wristband) may include a unique RFID identifier that associates the subject with the RFID tag. The RFID tag may also include the unique RFID identifier in any and all transmissions occurring from the RFID tag to one or more RFID sources. Thus, the system, via the one or more RFID sources, can receive data (from an RFID tag) that is uniquely associated with a subject. Accordingly, the system can collect data regarding a subject's play behavior and location as the subject proceeds through a particular environment. In at least one embodiment, the system may collect data (via RFID interactions) pertaining to a location of a subject within a particular environment, a proximity of a first subject to a second subject, interaction of a subject with an item, an interaction of a subject with an environmental feature (as described herein and henceforth referred to as an “experience”), and any combination of subject location, interaction and proximity to another subject.

Using RFID interaction data and other data described herein, the system can collect and analyze data to generate insights into a subject's behavioral trends in the particular environment (with respect to locations, objects, experiences, and other subjects therein). The system can perform one or more algorithmic methods, machine learning methods and pattern recognition methods to evaluate a subject's behavioral trends, predict one or more interests of the subject and generate content incorporating the one or more predicted subject interests. The system can be configured to generate an electronic communication that includes the generated content, transmit the electronic communication to the subject, or a representative or guardian thereof, and transmit the generated content to a server that hosts and, upon request, streams the generated content.

In one or more embodiments, the present technology further relates to using data associated with a subject in an interactive environment to, in real time, produce, update, and display a digital story that aligns with identified interests of the subject and/or is responsive to detected behaviors of the subject. In various embodiments, the system can detect and record subject behavior throughout the subject's time in a play environment. In at least one embodiment, the system can utilize recorded subject behavior as input to an iterative digital content process that directs the subject throughout the play environment, thereby personalizing and increasing immersion of play experiences.

The present systems and methods can include processes for iterative digital storytelling experiences that direct a subject toward specific locations, items (e.g., toys), and/or tasks in a play environment. For example, the present systems and methods can generate, and display to a subject, initial digital content, and the initial digital content can direct the subject to one or more specific locations, items, and/or tasks. The present systems and methods can determine that the subject interacted with the one or more specific locations, items, and/or tasks, and can generate, and display to the subject, secondary digital content that is at least partially based upon the initial digital content and the directed-to locations, items, and/or tasks.

In an exemplary scenario, a child walks into a “story cave” room. The story cave includes one or more projection sources configured to display digital content (e.g., in response to being triggered by the system). Upon entering the story cave, an RFID source interrogates the child's RFID wristband and a motion sensor detects movement of the child within a predefined proximity of the motion sensor. The RFID interaction and/or motion sensor interaction cause the system to generate and trigger the one or more projection sources to display, initial digital content. By the interrogated RFID wristband, the system identifies the child and retrieves a custom avatar of the child, and includes the custom avatar in the initial digital content. To generate the initial digital content, the system performs one or more generation processes including, but not limited to, retrieving, and/or processing tracked subject behavior to identify predict, one or more subject interests, expressing the identified one or more interests as one or more category identifies, identifying and retrieving appropriate pre-generated content by matching the one or more category identifiers (of the subject) to one or more category identifiers associated with stored content, organizing the retrieved pre-generated content into the initial digital content, and modifying the initial digital content to include one or more of customized narrations, animations, sounds and illustrations.

The initial digital content can show the custom avatar arriving in an animated story cave and discovering a map to a “toy testing lab” and a “toy city.” The toy testing lab and toy city can each be representative of additional play rooms. The initial digital content can further show a group of toys (e.g., such as, for example, an action figure, a stuffed bear, and a doll) struggling to assemble a vehicle (e.g., a toy brick construction set that can be assembled into a vehicle). The initial digital content can direct the custom avatar (e.g., and, thus, the child) to assist the toys by traveling to a toy testing lab and assembling a vehicle (e.g., out of toy construction bricks). The initial digital content can also instruct the child to present their assembled vehicle to an “inspector” (e.g., a staff member) for approval.

The child walks into the toy testing lab, whereupon another RFID source interrogates the child's RFID wristband. The child locates the toy construction bricks and assembles a vehicle. The child presents the vehicle to the staff member, and the staff member inputs data to the system (e.g., via an electronic tablet, etc.) confirming that the child has completed the task dictated by the initial digital content. The staff member instructs the child to return to the story cave for the next leg of their adventure. The child then returns to the story cave. The system, via RFID wristband interrogations and inputted data, detects that the child satisfied the dictated task and has returned to the story cave. The motion sensor detects movement of the child within the predefined proximity, and the system, in response, generates secondary digital via the one or more generation processes. The system then triggers the projection source to display the secondary digital content. The secondary digital content can show the custom avatar presenting an assembled vehicle to the toys, and the toys inviting the custom avatar to join them on a drive. The secondary digital content can then show the toys and the custom avatar traveling towards a sign that reads “Toy Tropolis” thereby directing the child to explore the toy city.

### Exemplary Embodiments

Referring now to the figures, for the purposes of example and explanation of the fundamental processes and components of the disclosed systems and processes, reference numerals designate corresponding parts throughout the several views.

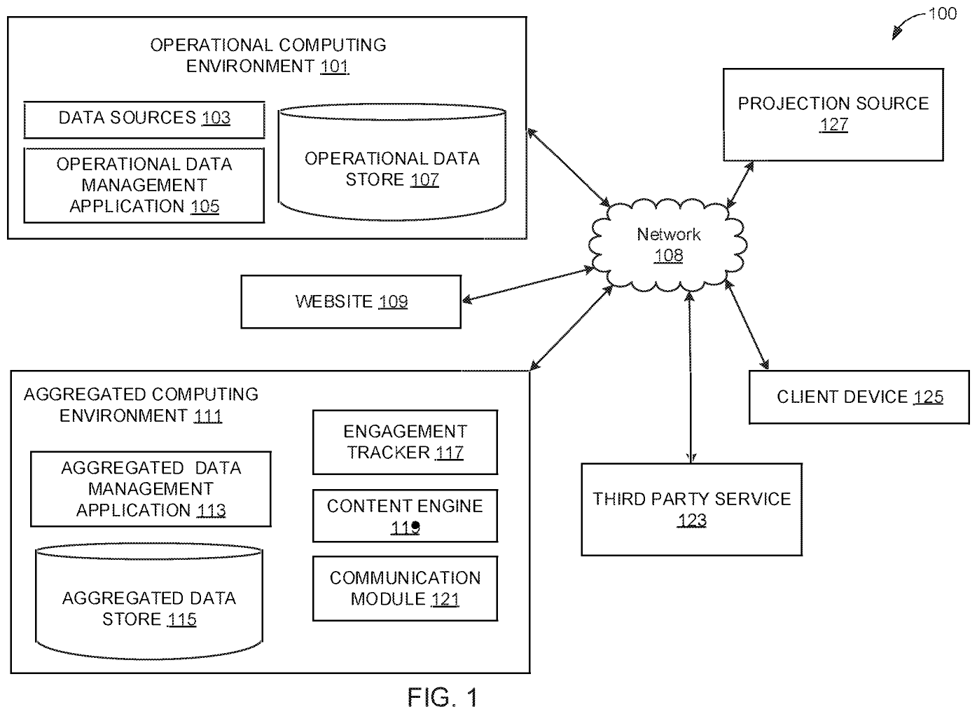

Reference is made to FIG. 1, which illustrates architecture of a networked computing environment 100. As will be understood and appreciated, the networked environment 100 shown in FIG. 1 represents merely one approach or embodiment of the present system, and other aspects are used according to various embodiments of the present system.

With reference to FIG. 1, shown is a networked environment 100 according to various embodiments. The networked environment 100 may include an operational computing environment 101, an aggregated computing environment 111, one or more third party service 123, and one or more client devices 125, all of which may be in data communication with each other via at least one network 108. The network 108 includes, for example, the Internet, intranets, extranets, wide area networks (WANs), local area networks (LANs), wired networks, wireless networks, or other suitable networks, etc., or any combination of two or more such networks. For example, such networks may include satellite networks, cable networks, Ethernet networks, and other types of networks.

The operational computing environment 101 and the aggregated computing environment 111 may include, for example, a server computer or any other system providing computing capability. Alternatively, the operational computing environment 101 and the aggregated computing environment 111 may employ computing devices that may be arranged, for example, in one or more server banks or computer banks or other arrangements. Such computing devices may be located in a single installation or may be distributed among many different geographical locations. For example, the operational computing environment 101 and the aggregated computing environment 111 may include computing devices that together may include a hosted computing resource, a grid computing resource, and/or any other distributed computing arrangement. In some cases, the operational computing environment 101 and the aggregated computing environment 111 may correspond to an elastic computing resource where the allotted capacity of processing, network, storage, or other computing-related resources may vary over time. In some embodiments, the operational computing environment 101 and the aggregated computing environment 111 may be executed in the same computing environment.

Various applications and/or other functionality may be executed in the operational computing environment 101 according to various embodiments. The operational computing environment 101 may include and/or be in communication with data sources 103. In at least one embodiment, the one or more data sources 103 can include, but are not limited to, RFID sources, computer vision sources, content sources, input sources, WiFi sources, Bluetooth sources, motion sensors, and other sources that generate data in response to detected physical phenomena. The operational computing environment 101 can include an operational data management application 105 that can receive and process data from the data sources 103. The operational data management application 105 can include one or more processors and/or servers, and, and can be connected to an operational data store 107. The operational data store 107 may organize and store data, sourced from the data sources 103, that is processed and provided by the operational data management application 105. Accordingly, the operational data store 107 may include one or more databases or other storage mediums for maintaining a variety of data types. The operational data store 107 may be representative of a plurality of data stores, as can be appreciated. Data stored in the operational data store 107, for example, can be associated with the operation of various applications and/or functional entities described herein. Data stored in the operational data store 107 may be accessible to the operational computing environment 101 and to the aggregated computing environment 111. The aggregated computing environment 111 can access the operational data store 107 via the network 108.

The aggregated computing environment 111 may include an aggregated data management application 113. The aggregated data management application 113 may receive and process data from the operational computing environment 101, from the website 109, from the third party service 123, and from the client device 125. The aggregated data management application 113 may receive data uploads from the operational computing environment 101, such as, for example, from the operational data management application 105 and operational data store 107. In at least one embodiment, data uploads between the operational computing environment 101 and aggregated computing environment 111 may occur manually and/or automatically and may occur at a predetermined frequency (for example, daily) and capacity (for example, a day's worth of data). As an example, a user may manually initiate an upload or the upload may be automatically performed according to a schedule or trigger by software or hardware.

The aggregated computing environment 111 may further include an aggregated data store 115. The aggregated data store 115 may organize and store data that is processed and provided by the aggregated data management application 113. Accordingly, the aggregated data store 115 may include one or more databases or other storage mediums for maintaining a variety of data types. The aggregated data store 115 may be representative of a plurality of data stores, as can be appreciated. In at least one embodiment, the aggregated data store 115 can be at least one distributed database (for example, at least one cloud database). Also, data stored in the aggregated data store 115, for example, can be associated with the operation of various applications and/or functional entities described herein. In at least one embodiment, the operational data store 107 and the aggregated data store 115 may be a shared data store (e.g., that may be representative of a plurality of data stores).

The operational data store 107 may provide or send data therein to the aggregated computing environment 111. Data provided by the operational data store 107 can be received at and processed by the aggregated data management application 113 and, upon processing, can be provided to the aggregated data store 115 (e.g., for organization and storage). In one embodiment, the operational data store 107 provides data to the aggregated data store 115 by performing one or more data batch uploads at a predetermined interval and/or upon receipt of a data upload request (e.g., at the operational data management application 105).

The aggregated computing environment 111 can include an engagement tracker 117 that tracks interactions of a client with electronic communications that may be generated at and transmitted from the aggregated computing environment 111. Data from the engagement tracker 117 can be used to optimize machine learning processes and other processes for predicting subject interests and generating content. The engagement tracker 117 can record information including, but not limited to, read receipts, link clicks, content observation metrics, and other information related to interactions with electronic communications. In one example, the engagement tracker 117 includes a review tool embedded within an electronic communication comprising a composition. In this example, for the composition, the review tool receives a positive or negative response (e.g., a thumbs-up or thumbs-down input) from a user account to which the electronic communication is transmitted. Continuing this example, based on receiving a thumbs-down input, the content engine 119 generates a new iteration of the content that differs in one or more aspects from the original and/or stores the information, which may be used in as an input to subsequent content generation processes associated with the user account. In at least one embodiment, the engagement tracker 117 associates tracked information with at least one user account corresponding to a subject. For example, the engagement tracker 117 may include a subject identifier (for example, a user ID) that is associated with a subject whose interaction with an electronic communication is being tracked. The subject identifier can be included in a data object sourced from a tracked interaction with the electronic communication.

The aggregated computing environment 111 can include a content engine 119 that analyzes play behavior data (and other associated information) and generates content, such as a composition, based on the analysis. In at least one embodiment, the content engine 119 determines the one or more interests of a subject by performing pattern recognition algorithms and/or machine learning processes to model data. Examples of machine learning processes and models include, but are not limited to, neural networks, random forest classification, and local topic modeling. From the model, the content engine 119 can output the one or more subject interests. The content engine 119 can use identified interests as an input to a digital content creation process. The digital content creation process can output custom digital content aligned with identified subject interests. The content engine 119 can receive data from the aggregated data store 115 and can provide content (e.g., expressed as electronic data) to the aggregated data store 115 and a communication module 121. The communication module 121 can generate electronic reports and messages based on one or more templates stored therein. The generated electronic reports may include analysis results and content produced by the content engine 119. The communication module 121 can transmit generated electronic reports to the client device 125. Thus, the aggregated computing environment 111 may receive data describing play behavior, store the data in the aggregated data store 115, collect engagement information, generate analyses of the play behavior data and digital content at the content engine 119, generate electronic reports (e.g., including analysis results and the content) at the communication module 121, and transmit reports, for example, to the website 109 and/or the client device 125.

The client device 125 is representative of a plurality of client devices that may be coupled to the network 108. The client device 125 may include, for example, a processor-based system such as a computer system. Such a computer system may be embodied in the form of a desktop computer, a laptop computer, personal digital assistant, cellular telephone, smartphone, set-top box, music player, web pad, tablet computer system, game console, electronic book reader, or one or more other devices with like capability. The client device 125 may include a display (not illustrated). The display may include, for example, one or more devices such as liquid crystal display (LCD) displays, gas plasma-based flat panel displays, organic light-emitting diode (OLED) displays, electrophoretic ink (E ink) displays, LCD projectors, or other types of display devices, etc. Thus, the client device 125 may possess all components, applications, and functions necessary to provide and receive data, via the network 108, to and from the operational computing environment 101, the aggregated computing environment 111 and the website 109. The display of the client device 125 may be suitable for visualizing received data (for example, digital content).

The client device 125 can receive electronic communications from the communication module 121. The client device 125 can render received electronic communications on an included display. For example, the client device 125 can render digital content on a display. The client device 125 can be a source of engagement data. For example, the engagement tracker 117 can collect, from trackable content accessed via the client device 125, engagement data associated with interaction of a client with received electronic communications.

The networked environment 100 can also include one or more projection sources 127. The projection sources 127 can include, but are not limited to, machines and apparatuses for providing visible displays of digital content. The projection sources 127 can receive commands from the operational computing environment 101 and/or the aggregated computing environment 111. In at least one embodiment, a received projection command can cause the projection sources 127 to display content provided in the command, or otherwise provided by the networked environment 100. Accordingly, upon receipt of a command, the projection sources 127 can process the command to obtain the content and display the same.

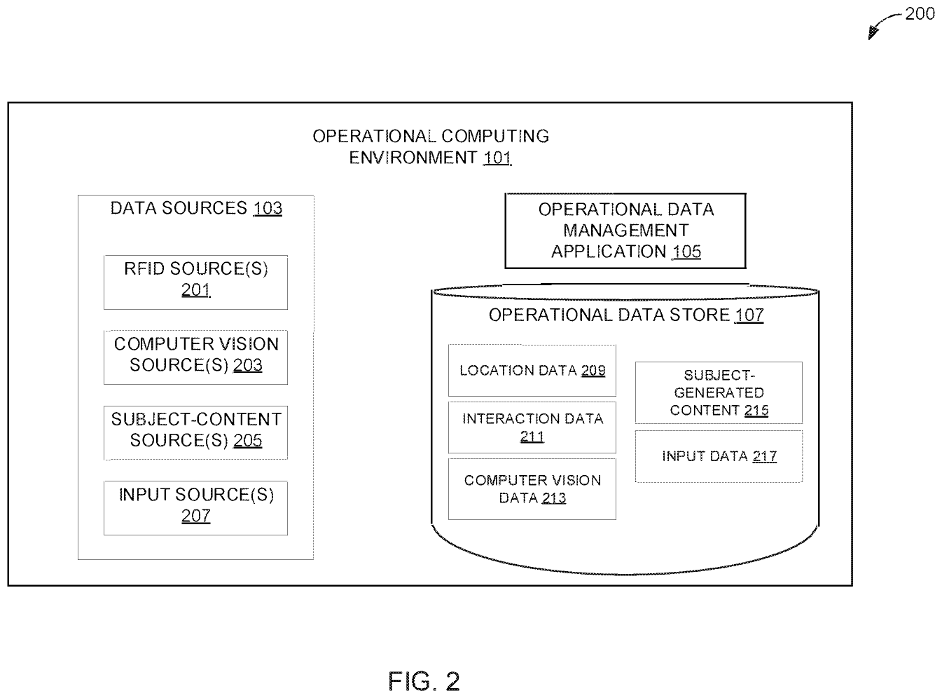

With reference to FIG. 2, shown is an operational computing architecture 200 according to various embodiments. The data sources 103 can include RFID sources 201, computer vision sources 203, content sources 205, and input sources 207. The RFID sources 201 can be one or more radio frequency identification (“RFID”) readers that may be placed throughout a particular physical environment. The RFID sources 201 can be coupled to the network 108 (FIG. 1). The RFID readers can interrogate RFID tags that are within range of the RFID readers. The RFID reader can read the RFID tags via radio transmission and can read multiple RFID tags simultaneously. The RFID tags can be embedded in various objects, such as toys, personal tags, or other objects. The objects may be placed throughout a play area for children. The RFID sources 201 can interact with both passive and active RFID tags. A passive tag may refer to an RFID tag that contains no power source, but, instead, becomes operative upon receipt of an interrogation signal from an RFID source 201. Correspondingly, an active tag refers to an RFID tag that contains a power source and, thus, is independently operative. In addition to an RFID tag, the active tags can include an RFID reader and thus function as an RFID source 201. The active tag can include a long-distance RFID antenna that can simultaneously interrogate one or more passive tags within a particular proximity of the antenna.

The RFID sources 201 and RFID tags can be placed throughout a particular physical area. As an example, the RFID sources 201 can be placed in thresholds such as at doors, beneath one or more areas of a floor, and within one or more objects distributed throughout the play area. In one embodiment, the RFID sources 201 can be active RFID tags that are operative to communicate with the operational data management application 105. In various embodiments, the RFID tags may be embedded within wearables, such as wristbands, that are worn by children present in a play area.

The RFID sources 201 and RFID tags may each include a unique, pre-programmed RFID identifier. The operational data store 107 can include a list of RFID sources 201 and RFID tags including any RFID identifiers. The operational data store 107 can include corresponding entities onto or into which the RFID sources 201 or RFID tag are disposed. The operational data store 107 can include locations of the various RFID sources 201 and RFID tags. Thus, an RFID identifier can be pre-associated with a particular section of a play area, with a particular subject, with a particular or object, or a combination of factors. The RFID tags can include the RFID identifier in each and every transmission sourced or a subset therefrom.

Passive RFID tags can be interrogated by RFID sources 201 that include active tags and that are distributed throughout a play area. For example, a passive RFID tag may be interrogated by active RFID tag functioning as an RFID source 201. The RFID source 201 can interrogate the passive RFID tag upon movement of the passive RFID tag within a predefined proximity of the active RFID source 201. The RFID source 201 can iteratively perform an interrogation function such that when the passive RFID tag moves within range, a next iteration of the interrogate function interrogates the passive RFID tag. Movement of a passive RFID tag within a predefined proximity of an RFID source 201 (e.g., wherein the movement triggers an interrogation or the interrogation occurs iteratively according to a defined frequency) may be referred to herein as a “location interaction.” The predefined proximate can correspond to a reading range of the RFID source 201.

The operational data management application 105 may receive a transmission from an RFID source 201 following each occurrence of a location interaction. A transmission provided in response to a location interaction may include a first RFID identifier that is associated with a passive tag and a second RFID identifier that is associated with an RFID source 201. In some embodiments, the transmission may include a transmission from both a passive and active tag, or may only include a transmission from an active tag. In instances where a transmission is provided only by an active tag (e.g., an active tag that has experienced a location interaction with a passive tag), the active tag may first receive an interrogation transmission from the passive tag, the interrogation transmission providing a first RFID identifier that identifies the passive tag. In some embodiments, the transmission can include multiple RFID identifiers associated with more than one passive tag. The RFID source 201 may read more than one RFID tag located within a reading range. The RFID source 201 may transmit a list of RFID identifiers for the RFID tags read along with an RFID identifier for the RFID source 201.

As one example, a child in a play area may wear a wristband that includes a passive RFID tag. The child may walk through a threshold into a particular area of the play area. The threshold may include an RFID source 201 that interrogates the child's RFID tag, thereby causing a location interaction. The location interaction may include, but is not limited to, the RFID tag receiving an interrogation signal from the RFID source 201, the RFID tag entering a powered, operative state and transmitting a first RFID identifier to the RFID source 201, and the RFID source 201 transmitting the first RFID identifier and a second RFID identifier (e.g., that is programmed within the RFID source 201) to an operational data management application 105. The operational data management application 105 can process the transmission and store data at an operational data store 107. The operational data management application 105 can determine the child is now within the particular area based on receiving the first RFID identifier and the second RFID identifier. The operational data management application 105 can utilize data relating the first identifier to the child and the second identifier to the particular area. Thus, a location interaction may allow the present system to record movement of a subject throughout a play area and, in particular, into and out of one or more particular areas of the play area.

The RFID sources 201 can also be included in one or more experiences configured and/or installed throughout a play area. In various embodiments, an experience may include, but is not limited to, a particular object (or set of objects), an apparatus and an interactive location provided in a play area. For example, an experience may include a particular train and a particular train zone of a play area. The particular train may include a passive RFID tag and the particular train zone may also include an RFID source 201 (e.g., disposed within a particular floor section of a play area). The RFID tag of the particular train and the RFID source 201 of the train zone may be in communication with each other. The RFID source 201 of the train zone and/or RFID tag of the particular train may also be in communication with an RFID tag of a subject (e.g., a subject wearing an RFID wristband) that enters the train zone and plays with the particular train. Per the present disclosure, an instance where communicative RFID activity occurs between a subject and an object and/or experience may be referred to as an “experience interaction.” Accordingly, the present system may receive (e.g., via transmissions from RFID sources 201) data associated with any experience interaction occurring within a play area.

The data sources 103 can include other triggers and/or detection-based sources including, but not limited to, projection sources, scanners, motion sensors, WiFi-based sources, and other electronic devices and apparatuses that can be triggered by or detect a subject. For example, a play environment can include one or more projection sources that include a motion sensor. The motion sensor can detect a subject, upon the subject moving within a predefined proximity of the motion sensor. Following detection, the motion sensor can trigger the one or more projection sources to display content. The one or more projection sources can also include a WiFi-based source that communicates with one or more additional projection sources and, in response to the first triggered projection, triggers subsequent displays of content.

In one example, upon a child entering a room, an RFID source 201 interrogates the child's RFID wristband and a motion sensor (installed within the projection source) detects movement of the child within a predefined proximity of the motion sensor. The motion sensor can trigger the projection source to generate a new display of a carnivorous dinosaur stealing the pterodactyl eggs, and the mother pterodactyl requesting assistance of the child in finding the stolen eggs that include RFID sources 201. The child can then explore the room to “find” the eggs by placing their RFID wristband against the eggs (thereby causing interrogation of the wristband by the RFID sources 201). Upon determining that the child has “found” the predetermined number of eggs, the system can trigger the projection source to display a scene of the eggs hatching. As described herein, the system can process data collected by the data sources 103 during the child's time in the dinosaur room and can determine one or more interests of the child, one or more metrics and/or insights regarding play behavior of the child, and the system can generate compositions, such as a digital story, based on the tracked interactions, interests, metrics, and insights.

The computer vision sources 203 can include one or more computer vision apparatuses placed throughout a play area. The computer vision sources 203 can include an overhead camera, a wall-mounted camera, or some other imaging device. The computer vision sources 203 can stream a live or recorded video stream to the operational data management application 105. In some embodiments, one of the computer vision sources 203 can provide an infrared video stream. A computer vision apparatus may include, but is not limited to, an imaging component that collects visual data from a play area, a processing component that processes and analyzes collected visual data, and a communication component that is operative to transmit collected and/or processed visual data and, in some embodiments, analysis results to an operational computing environment 101 and, in particular, to an operational data management application 105. In some embodiments, the computer vision sources 203 may include only an imaging component and a communication component, and analysis of collected and/or processed visual data may occur elsewhere (for example, in an operational computing environment 101 or in an aggregated computing environment 111). Visual data collected by the computer vision sources 203 may be processed and/or analyzed using one or more computer vision algorithms to obtain one or more computer vision outputs. The computer vision outputs can include, but are not limited to, traffic patterns that illustrate movement trends of subjects through a play area (or a particular area of a play area), dwell times that indicate time spent by one or more subjects in a play area (or a particular area), and object recognitions that identify a particular object in a play area, and may also identify an action being performed on the particular object.

For example, the computer vision sources 203 may collect visual data of a child playing with a train and train tracks in a toy room of a play area. The computer vision sources 203 may send the collected visual data to the operational data management application 105. The operational data management application 105 can analyze the visual data using one or more computer vision algorithms to generate one or more computer vision outputs. Based on the outputs, the operational data management application 105 can identify movement of the child into the toy room, provide a dwell time of the child within the toy room, and identify the train with which the child played. The system can also identify that the child constructed a toy railroad, and can determine that the child used blocks and other non-train toys to construct a railroad bridge crossing a projected river display, thereby suggesting a potential interest in construction (identified by the system, as described herein). In the same example, based on the potential interest in construction and railroads, the system can generate a composition centered around construction of a railroad bridge or similar element (e.g., a tunnel), and the child can be inserted into the composition as a character (e.g., represented by an avatar).

The content sources 205 can include one or more devices, assemblies and/or apparatus that allow a subject to produce customized content. For example, a content source 205 can be a toy review station where a child can record their own review of a toy and assign the toy a rating. The content sources 205 can include a communication component that provides subject-generated content (e.g., reviews, ratings, etc.) to an operational data management application 105. In some embodiments, communications from a content source 205 may also include an identifier associated with the subject that produced the subject-generated content. Thus, the content sources 205 may provide the present system with data that identifies a subject and provides subject-generated content produced by the subject (via the content sources 205).

The input sources 207 can include one or more electronic devices that receive manual input from a system operator (for example, an employee monitoring subjects within a play area). The input sources 207 can also include an RFID interrogation component that allows the system operator to interrogate RFID tags, or the like, of one or more subjects in the play area (e.g., to identify the one or more subjects via RFID identifiers). The input sources 207 can include, but are not limited to, desktop computers, laptop computers, personal digital assistants, cellular telephones, smartphones, web pads, and tablet computer systems. In at least one embodiment, the system includes, in the input sources 207, an interface for entering manual inputs. The interface can include one or more pre-generated forms and/or templates with fields for inputting various subject information, subject data, metrics, and other observations. The input sources 207 can be operative to communicate with an operational data management application 105. The input sources 207 can communicate received inputs to the operational data management application 105 via a network (for example, a network 108 illustrated in FIG. 1). Inputs received by the input sources 207 can include, but are not limited to, an identifier (e.g., such as an RFID identifier as described herein) that is associated with a subject, object, location, etc., observations of subject play behavior within a play area (or a particular area thereof), observations of play trends within a play area (for example, an observation that a particular play experience is most popular amongst subjects), and other information and/or data related to activities, subjects, objects and locations in a play area. The inputs can be in one or more formats including, but not limited to, character strings, numeric values, and Boolean values.

As described herein, the operational data management application 105 may receive data from one or more data sources 103. The operational data management application 105 can process and convert received data into one or more formats prior to providing the data to the operational data store 107. The operational data store 107 may organize collected and received data in any suitable arrangement, format, and hierarchy. For purposes of description and illustration, an exemplary organizational architecture is recited herein; however, other data organization schema are contemplated and may be utilized without departing from the spirit of the present disclosure.

The operational data store 107 may include location data 209. The location data 209 can include data associated with RFID location interactions (as described herein). The location data 209 can include RFID identifiers associated with one or more subjects and one or more locations (e.g., in a play area where RFID sources 201 have been placed). The location data 209 may be time series formatted such that a most recent entry is a most recent location interaction as experienced by a subject and a particular location in a play area, and recorded via RFID sources 201. Accordingly, the location data 209 can serve to illustrate movement of a subject into and out of a particular location in a play area. One or more entries associated with a location interaction may include, but are not limited to, a subject RFID identifier, a location RFID identifier, and a timestamp associated with the location interaction.

In an exemplary scenario, a subject with an RFID wristband (as described herein) crosses a threshold (e.g., a doorway) that includes an RFID source 201. In the same scenario, as the subject passes within a predefined proximity (for example, 1 m) of the RFID source 201, the RFID source 201 interrogates the RFID wristband and receives a subject RFID identifier. Continuing the scenario, the RFID source 201 transmits data (e.g., the subject RFID identifier, a location RFID identifier and metadata) to an operational data management application 105. The operational data management application 105 can receive and process the data, and provide the processed data (e.g., now location data 209) to an operational data store 107. The operational data store 107 can organize and store the location data 209. Organization activities of the operational data store 107 can include, but are not limited to, updating one or more particular data objects, or the like, to include received location data 209 and/or other data (as described herein). In at least one embodiment, the operational data store 107 may organize particular location data 209, or any data, based on an associated subject RFID identifier (e.g., where the association is that the subject identifier was received concurrently with the data to be organized).

The operational data store 107 can include interaction data 211. The interaction data 211 can be sourced from experience interactions and data thereof. Thus, interaction data 211 can include data associated with RFID object and experience interactions. The location data 209 can include data including, but not limited to, RFID identifiers associated with one or more subjects and one or more experiences (e.g., that provided in a play area and include RFID sources 201). The interaction data 211 may be time series formatted such that a most recent entry is a most recent experience interaction as experienced by a subject, one or more objects, and/or particular regions of a play area, and recorded via RFID sources 201. Accordingly, the interaction data 211 can serve to illustrate instances where a subject experienced a particular experience interaction in a play area. One or more entries associated with an experience interaction may include, but are not limited to, a subject RFID identifier, one or more object RFID identifiers, a location RFID identifier, and a timestamp associated with the experience interaction.

In an exemplary scenario, a subject with an RFID wristband engages with an experience that includes an RFID source 201. In the same scenario, as the subject passes within a predefined proximity (for example, 1 m) of the RFID source 201, the RFID source 201 interrogates the RFID wristband and receives a subject RFID identifier. Continuing the scenario, the RFID source 201 (and/or the RFID wristband) transmits data (e.g., the subject RFID identifier, one or more object RFID identifiers, a location RFID identifier and metadata) to an operational data management application 105. In the same scenario, the operational data management application 105 receives and processes the data, and provides the processed data (e.g., now interaction data 211) to an operational data store 107. Continuing the scenario, the operational data store 107 organizes and stores the location data 209.

The operational data store 107 can include computer vision data 213. The computer vision data 213 can include processed or unprocessed image data (and metadata) from one or more computer vision sources 203. Accordingly, the operational data management application 105 may receive data from the computer vision sources 203, process the data (if required) and provide the data (e.g., as computer vision data 213) to the operational data store 107 that organizes and stores the provided data. The operational data store 107 can include subject-generated content 215 that is received from one or more content sources 205. Accordingly, the operational data management application 105 may receive data (including subject-generated content) from the content sources 205, process the data (if required) and provide the data (e.g., as subject generated content 215) to the operational data store 107 that organizes and stores the provided data. The subject-generated content 215 may include a subject identifier (for example, a user ID, subject RFID identifier, etc.) that is associated with a particular subject that produced the subject generated content 215. Thus, the present system may track and store subject- generated content 215 and associate (programmatically, in a database) a subject with the subject-generated content 215.

The operational data store 107 can include input data 217. The input data 217 can include free form and/or numerical information, such as text descriptions and numeric ratings, that are sourced from one or more input sources 207. The input data 217 can also include one or more subject identifiers (for example, a subject RFID identifier, user ID, etc.) that associates the input data 217, or at least one data object thereof, with a particular subject (e.g., that played or is currently playing in a play area). The input data 217 can include data from surveys and profiles that are populated based on inputs of a subject or other user, such as a guardian of the subject or a staff member of a play environment. In one example, input data 217 includes observational data entered by a staff member that observes play behavior of a child in a music-themed toy room. In another example, input data 217 includes feedback from a survey response submitted by a parent, the survey being presented to the parent based on their child's admittance to and/or departure from a play environment. The input data 217 can provide additional information regarding a subject, such as known interests, disinerests, and play behaviors. In one example, a subject (or guardian thereof) is presented a survey associated with the subject's user account, the survey including a plurality of questions associated with play behavior of the subject and being directed towards assessing the interests and cognitive development of the subject. In this example, the responses to the survey (e.g., which may be received via a client device 175) are saved in the aggregated computing environment 161 (or other appropriate location) and may be retrieved to augment interest prediction and recommendation processes for the subject.

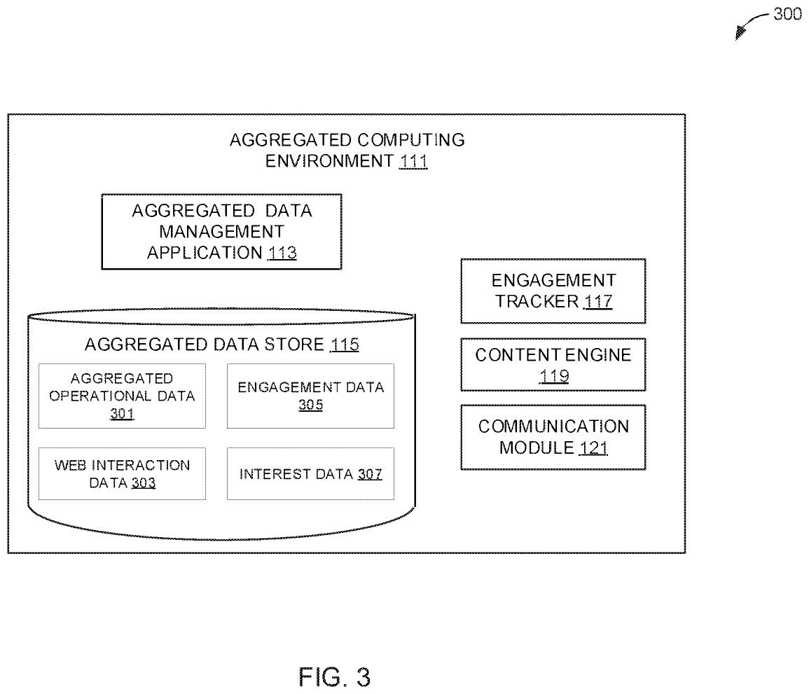

With reference to FIG. 3, shown is an aggregated computing environment architecture 300, according to various embodiments. The aggregated computing environment 111 may include, but is not limited to, an aggregated data management application 113, an aggregated data store 115, an engagement tracker 117, a content engine 119, and a communication module 121. The aggregated data store 115 can include aggregated operational data 301. The aggregated operational data 301 can include location data 209, interaction data 211, computer vision data 213, subject-generated content 215, and input data 217. The aggregated operational data 301 can be updated through multiple uploads from the operational data store 107. Because the aggregated data store 115 can receive regular uploads of data, the aggregated operational data store 115 may continuously update the aggregated operational data 301 to include most recently uploaded data.

The aggregated data store 115 can also include web interaction data 303. The web interaction data 303 can refer to data sourced from recorded interactions of one or more subjects with at least one website 109. The aggregated data management application 113 can receive the web interaction data 303 from a web interaction tracking module (not illustrated) that is running on the one or more websites 109. The web interaction data 303 can include, but is not limited to, website interaction data objects, or the like, that associate a particular subject with one or more aspects of the website 109 with which the subject interacted. The web interaction data 303 may provide information regarding one or more particular interests, trends, and/or affiliations of one or more subjects (e.g., that interacted with the website 109).

The aggregated data store 115 can include engagement data 305. The engagement data 305 can be sourced from the engagement tracker 117. The engagement data 305 can include, but is not limited to, read receipts, link clicks, content observation metrics, and other information related to interactions with electronic communications. The engagement data 305 may be organized (e.g., by the aggregated data store 115) into one or more data objects. The one or more data objects may be organized based on one or more subject identifiers (e.g., a user ID) that are included in the engagement data 305. For example, the engagement data 305 may include at least one data object (such as a data array) for each subject whose interaction with an electronic communication has been tracked (e.g., by the engagement tracker 117).

The aggregated data store 115 can include interest data 307, which can include historical data (e.g., associated with previous inputs and outputs of content generation processes). In various embodiments, the interest data 307 includes historical content information relating to one or more of toys, games, events, off-site activities, locations and experiences previously identified (as described herein) to be of interest to a subject. The interest data 307 can be associated with each of one or more subjects to which the content were provided (e.g., via the communication module 121). In at least one embodiment, associations between the interests and each of the subjects may be sourced from the subject identifiers (e.g., user IDs) that are each uniquely associated with a subject (e.g., that interacted with an electronic communication provided by the communication module 121). The associations may also be provided by data objects relating the one or more subject identifiers to one or more category identifiers (e.g., that provide classifications of interests).

In various embodiments, data included the data store 115 may be anonymized. For example, the data can be absent any personally identifying information, or may otherwise securely encrypt and/or encode any personally identifying information. For example to achieve anonymization, the data can be encrypted and/or tokenized such that personally identifying information is rendered unusable without performing steps to decrypt and/or detokenize the data. As another example, data strings or sequences used identify subjects (e.g., subject identifiers, etc.) can be encrypted and/or tokenized such that a relational table (stored in a disparate, secure database) and/or algorithmic processes are required to associate the data strings or sequences with personally identifying information. In other words, the present system may anonymize, secure and/or be devoid of personally identifying information.

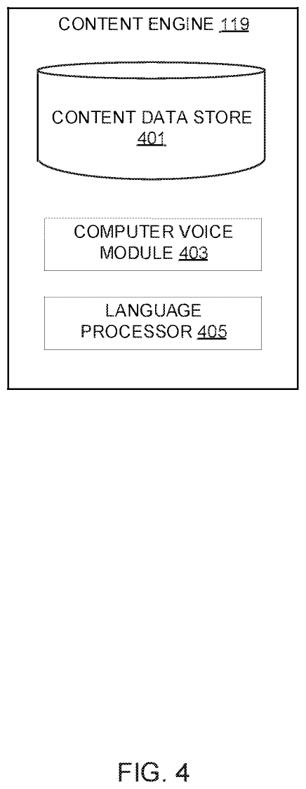

With reference to FIG. 4, shown is a content engine scheme 400, according to various embodiments. The content engine 119 can analyze data (e.g., from the aggregated data store 115) and generate content, which can be stored in the content data store 401. In other words, the content engine 119 can, using collected data, analyze and evaluate behavior of a subject in a play area, identify one or more interests of the subject and, based on the one or more identified interests, automatically generate content (for example, a digital story) that appeals to the one or more identified interests. For example, the content engine 119 may analyze data of a child who spent most of their time (in a play area) playing with a wizard toy in a castle-themed room. In the same example, the content engine 119 may identify that the child a) enjoys playing with wizard toys and b) enjoys playing in castle-themed environments. Continuing the same example, the system, by processing the identified interests, may automatically output or generate a digital story that features the child and a wizard, and is set in a castle setting.

The content engine 119 can also include a content data store 401, computer voice module 403, and a language processor 405. The content data store 401 can store a multitude of media, digital story templates, and other pre-generated content that may be inserted into a digital story. For example, the content data store 401 can include a digital story template based on themes of each room or section of a play area. Other pre-generated content stored by the content data store 401 can include, but is not limited to, images (for example, images of story characters, settings, objects, etc.), animations, audio recordings, videos, and scripts and/or other documents that provide organization and/or narration for a digital story. The content data store 401 may organize pre-generated content using the one or more category identifiers. Accordingly, the content engine 119 may perform a content generation process by performing one or more actions including, but not limited to, processing tracked behavior of a subject to identify or predict one or more interests, expressing the identified one or more interests as one or more category identifies, identifying and retrieving appropriate pre-generated content by matching the one or more category identifiers (of the subject) to one or more category identifiers associated with content stored in a content data store 401, organizing the retrieved pre-generated content into a digital story, and modifying the digital story to include one or more of customized narrations, animations, sounds, and illustrations.

The computer voice module 403 can automatically generate computer voice sound clips that can be inserted into a digital story. In various embodiments, the computer voice module 403 may generate computer voice sound clips using more than one voice. Accordingly, the computer voice module 403 can generate computer voice sound clips for both singularly-voiced narrations and multi-voiced dialogues. In at least one embodiment, the computer voice module 403 can receive and process scripts and/or other sound clip sources to generate one or more sound clips that are audible recitations of the scripts and/or other sound clip sources. The computer voice module 403 can also receive scripts, or the like, from a language processor 405. The language processor 405 can generate customized narrations, descriptions, and other story-related language data. In at least one embodiment, the language processor 405 can receive stored scripts from the content data store 401 and modify the stored scripts to produce customized scripts for a story. For example, the language processor 405 can receive (from the content data store 401) a script for a story set in a castle. In the same example, the language processor 405 can modify the script to include a particular subject (identified via a subject identifier provided to the content engine 119) and one or more characters, settings and activities that are included to appeal to one or more identified interests of the particular subject. In other words, the language processor 405 can leverage identified subject interests and pre-generated content to produce customized narrations and scripts for generated content.

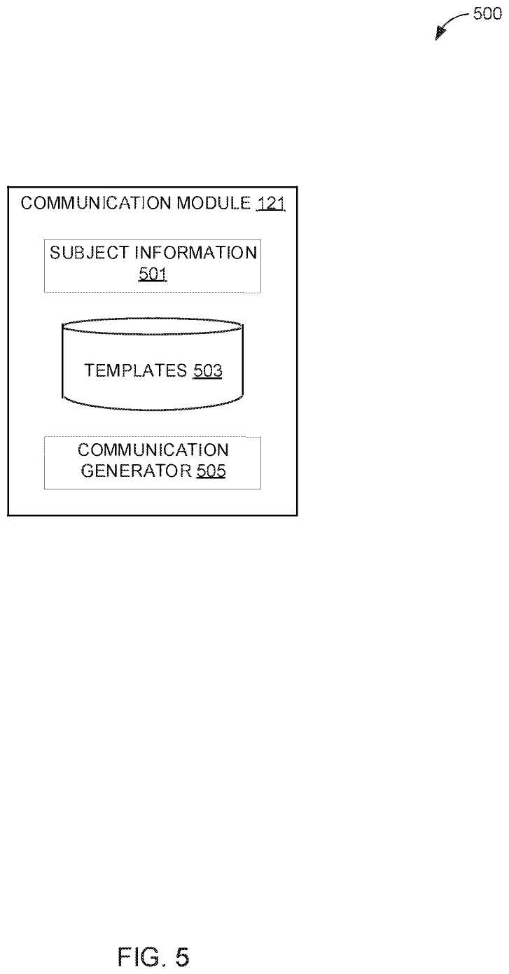

With reference to FIG. 5, shown is a communication module architecture 500 according to various embodiments. The communication module 121 can include subject information 501. The subject information 501 can include contact information for one or more subjects that visit a play area and/or access the website 109. The subject information 501 can be stored in one or more databases included in or operatively connected to the communication module 121. In at least one embodiment, the subject information includes only subject identifiers (for example, user IDs), and identifying information for corresponding subjects may be stored elsewhere (for example, in a secured third party database, in a separate cloud database, etc.). Thus, in at least one embodiment, the subject information 501 may be effectively anonymized. The communication module 121 can also include one or more templates 503. The one or more templates 503 can be templates for electronic communications that are used by a communication generator 505 to construct and populate personalized communications for one or more subjects. For example, a template 503 can be an email template with fields for inserting subject information 501 and content. The communication generator 505 can include a processor that retrieves and converts subject information 501, templates 503, and content into a formalized, professional electronic communication. The communication generator 505 can also include and/or be operatively connected to a server that transmits generated electronic communications.

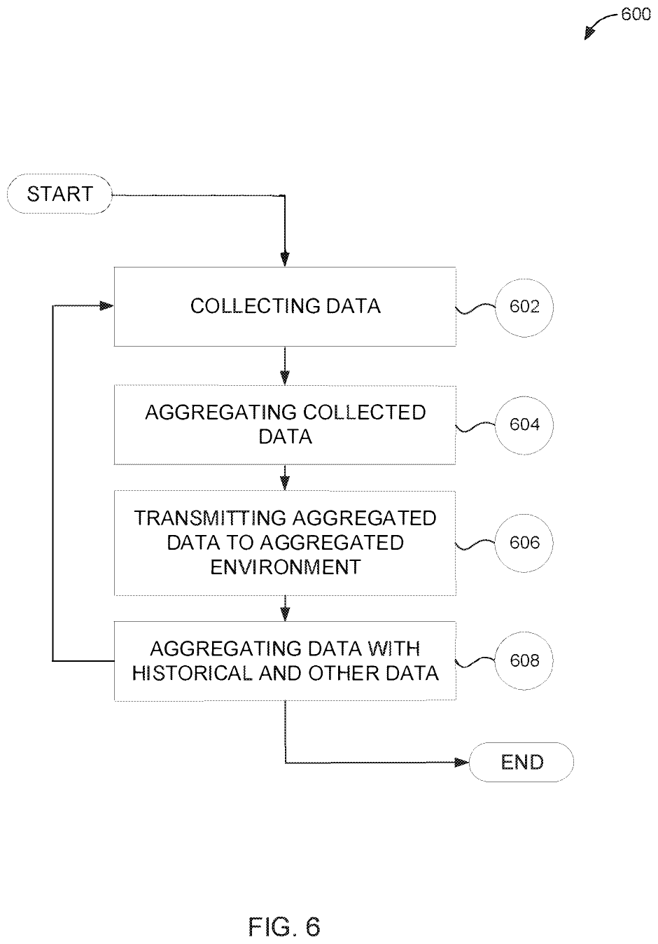

With reference to FIG. 6, shown is a data aggregation flowchart 600, according to various embodiments. As will be understood by one having ordinary skill in the art, the steps and processes shown in FIG. 6 (and those of all other flowcharts and sequence diagrams shown and described herein) may operate concurrently and continuously, are generally asynchronous and independent, and are not necessarily performed in the order shown. As an alternative, the flowchart of FIG. 6 may be viewed as depicting an example of elements of a method implemented in the operational computing environment 101 according to one or more embodiments.

At step 602, the system collects data from a play area. The collecting can be performed by one or more data sources, for example, data sources 103 (FIG. 1), and data can be transmitted to the operational data management application 105 (FIG. 1). The operational data management application 105 can process and provide the data to the operational data store 107 (FIG. 1). Data collection can occur at one or more predetermined frequencies and/or may occur continuously. In at least one embodiment, data collection can be performed automatically and/or manually.

At step 604, the system aggregates operational data. Operational data aggregation can include, but is not limited to, associating data with a specific subject (for example, via a subject identifier). To achieve operational data aggregation, the system can organize data collected within a predetermined interval (for example, one day, one week, one month, six months, or one year) by associating the collected data with a subject identifier and, in some embodiments, generating one or more data objects. In various embodiments, each data object may include data associated with at least one subject (e.g., as indicated by a subject identifier therein). Operational data aggregation may be performed at one or more servers included in and/or operatively connected to the system.

At step 606, the system transmits, via a network, aggregated operational data to an aggregated computing environment 111 (FIG. 1). Specifically, the system can transmit the aggregated operational data to an aggregated data management application 113 (FIG. 1). Aggregated operational data transmission can occur at one or more predetermined frequencies and/or may occur continuously. In at least one embodiment, aggregated operational data transmission can be performed automatically and/or manually. In at least one embodiment, the present system performs aggregated operational data transmission by uploading, via a server, the aggregated operational data to a cloud computing environment (which may be the aggregated computing environment) that provides long term data storage and data processing services.

At step 608, the system further aggregates the transmitted aggregated operational data with historical data (e.g., previously received aggregated operational data) and other data, including but not limited to, web interaction data, engagement data, and interest data. The system can perform data aggregation by appending received aggregated operational data to the historical data. The system may organize the newly aggregated data by subject identifier, by date, by location collected (e.g., by location RFID identifier), by room (e.g., room of a play area) and/or by a combination of elements described herein. All aggregated data (and, by extension, all data in the present system) may be organized and stored using subject identifiers (such as user IDs) that do not include personally identifying information. In at least one embodiment, the system stores all data anonymously and performs subject communication activities by matching a subject identifier with a database of subject identifying information (for example, a database that relates user IDs to subject email addresses). Finally, the steps illustrated in FIG. 6 may occur continuously and with repetition such that data is collected and aggregated operationally and globally on a continual basis.

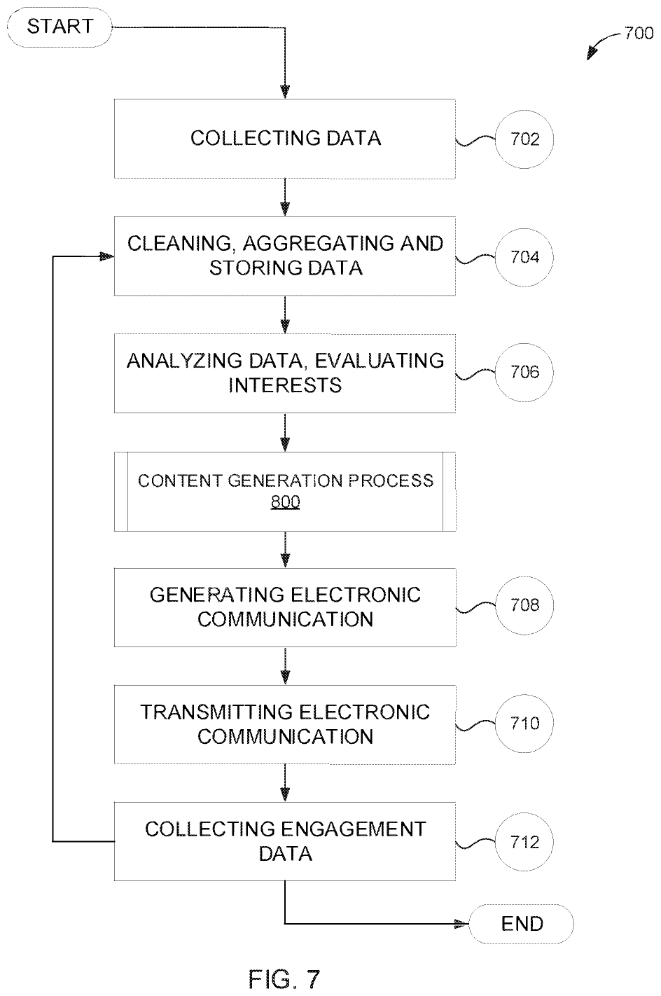

With reference to FIG. 7, shown is a content flowchart 700 according to various embodiments. As an alternative, the flowchart 700 of FIG. 7 may be viewed as depicting an example of elements of a method implemented in the networked environment 100 according to one or more embodiments. At step 702, the system can collect data documenting behavior of a subject. The data can be collected (e.g., or received) from one or more data sources dispersed throughout a physical environment (for example, data sources 103). In at least one embodiment, the one or more data sources can include, but are not limited to, RFID sources, computer vision sources, content sources, input sources, WiFi sources, Bluetooth sources, motion sensors, and other sources that generate data in response to detected physical phenomena. As described herein, collected and/or received data may be transmitted, via network, to an operational computing environment where the data is processed at an operational data management application and operationally aggregated, organized, and stored at an operational data store. The operational data store can include, but is not limited to, location data, interaction data, computer vision data, input data, and subject-generated content.

Data can also be collected from a website (for example, a website 109). The website data can include information describing interactions of the subject with website content. For example, the website data can include, but is not limited to, links (e.g., that the subject clicked), forms filled out by the subject, content viewed by the subject (for example, videos), and other website analytics. The website data can be collected and/or received from a website interaction database, or the like, that stores historical website data (e.g., and organizes the historical website data based on one or more subject identifiers. The website data can be collected by the operational computing environment and/or by an aggregated computing environment.

At step 704, data in the operational data store is transmitted to an aggregated computing environment. The data can be received and processed at an aggregated data management application. Data processing, at the aggregated management application, can include one or more processes and techniques for cleaning data. The one or more processes can include, but are not limited to removing and/or imputing missing data values, null data values, duplicate data values, and other potentially erroneous and/or outlier data values. Following processing at the aggregated data management application, the cleaned data can be provided to an aggregated data store. The aggregated data store can include aggregated operational data, web interaction data, engagement data, and interest data. The aggregated data store can organize the cleaned data with historical data therein by appending the cleaned data to historical data that is associated with the subject. In at least one embodiment, the aggregated data store can organize data by subject, by date, by location and/or source collected, by play area region (e.g., a specific section of a play area). In various embodiments, the aggregated data may organize data based on any data element or subject factor provided herein and other data organization schema are contemplated. The aggregated data store can organize data automatically and/or manually (e.g., in response to receipt of a command at a server operatively connected to the data store).

At step 706, the system initiates a data analysis, interest identification and content generation process. The content engine can perform any and/or all processes involved in analyzing and evaluating subject data, identifying subject interests, and generating customized digital content based on identified subject interests. In some embodiments, data analysis and evaluation may be performed at one or more other processors, and results thereof may be provided, via a network, to the content engine. The content engine can automatically and/or manually retrieve data on a subject (or a plurality of subjects) from the aggregated data store. In at least one embodiment, the content engine retrieves data from the data store by providing a data request that specifies a subject identifier, or other organizational key, indicating a specific set of data to be retrieved from the aggregated data store.

The content engine can perform analytical and evaluation processes that may include, but are not limited to, algorithmic techniques and/or data modeling methods. By performing analytical and evaluation processes, the content engine can compute one or more subject metrics. The one or more subject metrics can include, but are not limited to, time spent in each room and/or section of a play area, number of times the subject participated in a specific activity or experience, one or more toys that the subject played with most frequently, one or more toys that the subject included in subject-generated content (for example, one or more toys that the subject reviewed and rated), and one or more socialization metrics (for example, metrics that indicate whether the subject moved through the play area alone or with other subjects. In at least one embodiment, the content engine specifically leverages RFID data and/or computer vision data to generate the one or more subject metrics that are related to evaluating movement and play behavior of a child in the play area.

The following paragraph provides an exemplary scenario of the above data collection, organization, and evaluation steps. In an exemplary scenario, a child plays in a play area. As the subject plays, one or more data sources (e.g., data sources 103) collect data that describe the movement of the subject from one room of the play area to other rooms, describe which toys the subject played with, describe whether the child played alone or with others, and/or describe experiences with which the child engaged. The data sources provide the data to an operational computing environment that processes and aggregates the received data and transmits the received data to an aggregated computing environment. The aggregated computing environment receives, processes and organizes the data with historical data associated with the child (e.g., via a subject identifier included in all collected and received data). Following the data organization, the content engine retrieves, from an aggregated data store, the received data and other data (for example, web interaction data, engagement data, and other historical data) that is associated with the child. The content engine then applies one or more algorithmic and/or data modeling techniques to analyze and evaluate the retrieved data and generate one or more subject metrics, including dwell time metrics for a time that the child spent in each room of the play area and also including toy affinity metrics for one or more toys with which the child played.

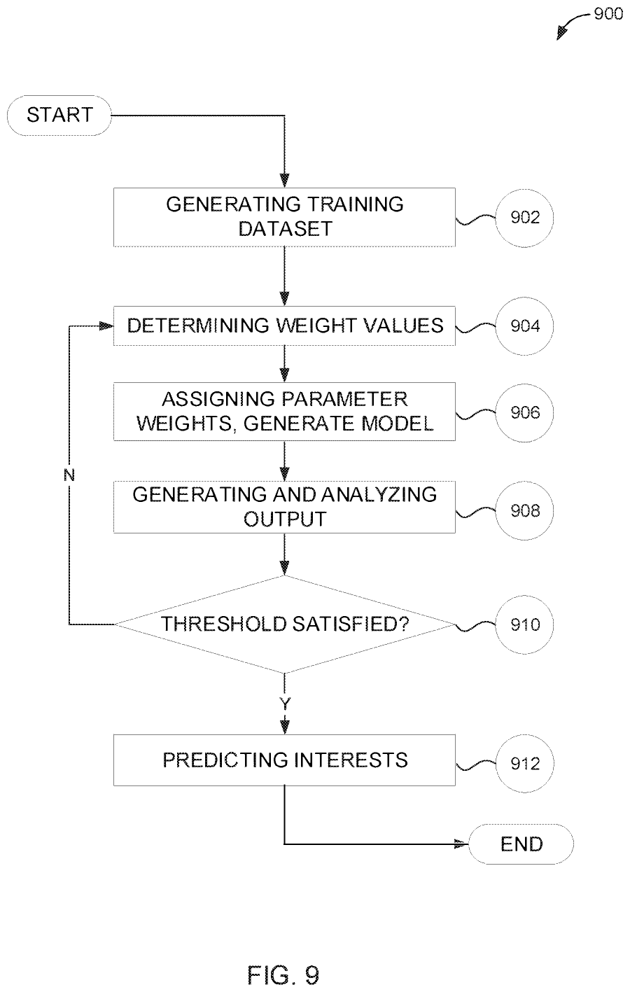

The system can also apply machine learning and/or other artificial intelligence (AI) processes to analyze collected data and generate complex analyses of subject play behavior. In one example, the system performs a machine learning process 900 (FIG. 9) to analyze interaction data and other data and predict interests based on the analysis. The machine learning processes can formulate insights into a subject's cognitive, physical, linguistic, and social-emotional development.

The machine learning processes can formulate analyses of play behavior including, but not limited to, attention span (for example, how long a child interacts with a play environment element and/or plays in each area of the play environment), questioning skills (for example, whether or not a child completed a play objective in a typical or atypical manner), working memory (for example, how much time a child took to perform a memory-based activity compared to average performance times), pattern recognition (for example, how much time a child took to complete a puzzle-based activity and strategies the child utilized to completed the activity), category formation (for example, what types of toys a child played with in combination), problem solving (for example, strategies a child utilized to complete a “scavenger hunt” activity), fine motor skills (for example, how precisely a child played a musical instrument), gross motor skills (for example, whether or not a child was able to operate a push toy), sensory processing (for example, whether a child avoided areas with particular sensory inputs, such as crowds, loud noises, projected content, etc.), decision making, and social and self-awareness (for example, how frequently a child played with others and which role the child occupied when playing with others, such as leader, equal partner, follower, etc.), self-management (for example, how often a child required assistance of a staff member to complete a task or resolve conflict), relationship skills (for example, how a child reacted to a disagreement with another child over turns playing with a toy), and language development (for example, how effectively and how often a child communicated with other children).

The system can also include a set of rules enforced in a play environment. The machine learning and Al processes can analyze collected play data to determine if a subject broke any of the rules while playing in the play environment. For example, a play environment may enforce a rule forbidding explicit hand gestures. The system can analyze computer vision and input data, and determine that a child made an explicit hand gesture. As another example, a play environment may enforce rules forbidding acts of violence and acts of impoliteness and/or theft. The system can analyze computer vision and input data, and determine that a first child struck a second child, after the second child took a toy with which the first child was playing. The system can generate analyses indicating that both children displayed poor social and self-awareness skills, poor self-management skills, and poor relationship skills. The system can include, in an electronic report for each child, a list of rules that the child broke, the circumstances and actions associated with the broken rules, and the skill proficiencies demonstrated by the child. The system can also include, in an electronic report, content comprising narratives and/or other elements directed towards mitigating or improve upon deficiencies in skill proficiencies. Continuing the above example, the system may include, in each electronic report, content centered around a sports team and in which the narrative emphasizes cooperation of two or more subjects and/or award sharing behavior.

Also at step 706, the content engine leverages analyses and evaluations of retrieved subject data to identify experiences, activities, resources and/or objects (e.g., toys, games, etc.) that the subject may enjoy. To identify the interests, the content engine applies one or more machine learning processes to model the retrieved subject data and/or one or more computed subject metrics. The one or more machine learning processes can include, but are not limited to, random forest classification, neural network modeling, gradient boosting, and other machine learning techniques. For example, the content engine can perform random forest classification to generate a machine learning model that predicts interests (e.g., in toys, activities, etc.) of the subject based on known interests and behaviors of the subject (e.g., as identified via analyses and evaluations of the retrieved data).

The content engine can also make comparisons between one or more subjects. For example, the content engine may compare identified patterns and interests of a first subject to identified patterns and interests of a second subject in order to generate content supported by identified similarities between the first and second subject. In other words, the system can identify interests of a first subject, compare the first subject interest to interests and behaviors of a second subject to influence the generation of content for the first subject. For example, the content engine can identify, based on collected behavior data and using present methods, that a first subject enjoys playing with animal toys in a barnyard-themed room of a play area. Continuing this example, the content engine can determine that a second subject with similarly identified interests was provided content including a barnyard narrative and that the second subject interacted with the content at a level satisfying a predetermined threshold (e.g., 30 minutes of interaction, 1 hour, and etc.). In the same example, based on a determined success of the second subject content, the content engine can generate and provide the first subject with content including a similar barnyard narrative.

In at least one embodiment, the content engine leverages historical data from the aggregated data, or another data source, to train and validate one or more models produced via machine learning methods. Data used to train and validate machine learning models (of the present system) can include, but are not limited to, subject purchase history (e.g., provided by a website 109 and/or a third party service 123), website analytics (e.g., provided by a website 109), survey responses (e.g., as provided by an engagement tracker 1170 and/or a website 109), and manual inputs. The content engine can perform one or more pattern recognition processes (that may or may not include machine learning techniques and/or classification algorithms) to determine one or more patterns from the retrieved data. For example, the content engine may execute a pattern recognition process (on retrieved data) and identify that a subject played with a particular wizard toy in a magic-themed room of a play area. In the same example, the content engine may use an output pattern (e.g., produced via the pattern recognition process) to generate a content comprising a magic-themed narrative and related imagery. Thus, the present system can record and analyze child play behavior in a play area, and, based on analyses and evaluations of child play behavior, automatically predict child interests and generate content with which the child may also be interested (e.g., based on the predicted child interests).

In one or more embodiments, the content engine may include artificial intelligence (“AI”) processes that identify insights and patterns in retrieved subject data. For example, the Al processes can identify patterns in RFID and computer vision data to determine that a first subject and a second subject are friends. The Al processes can provide the relation to the system, as an input to the content generation process. The system can then generate digital content that includes both the first subject and the second subject. As another example, the Al processes can determine patterns in digital content engagement data to determine a set of idealized digital content elements (e.g., elements of digital content that contributed to high levels of engagement with the digital content), and can provide the idealized digital content elements to the system, thereby optimizing subsequent content generation processes.

In various embodiments, an output of the interest identification process can include, but is not limited to, one or more toys, activities, experiences, and/or locations that the subject may enjoy (e.g., based on trained and validated machine learning models). In at least one embodiment, the system stores identified interests in a content data store (as described herein). The system may associate identified interests with a corresponding subject by organizing the identified interests with a subject identifier. The identified interests may be expressed by the system as one or more category identifiers that associate a particular interest with particular data (e.g., pre-generated story templates, images, animations, etc.) stored in the content data store. Thus, interests provided as an output of the interest identification process can be organized and formatted into one or more category identifiers. For example, a subject's behavior may be analyzed by a content engine that identifies a “wizard interest.” In the same example, the “wizard interest” may be organized and formatted by the system by associating, in an operational data store, a “wizard” category identifier with a subject identifier (thereby establishing, programmatically, that the subject is interested in wizards).

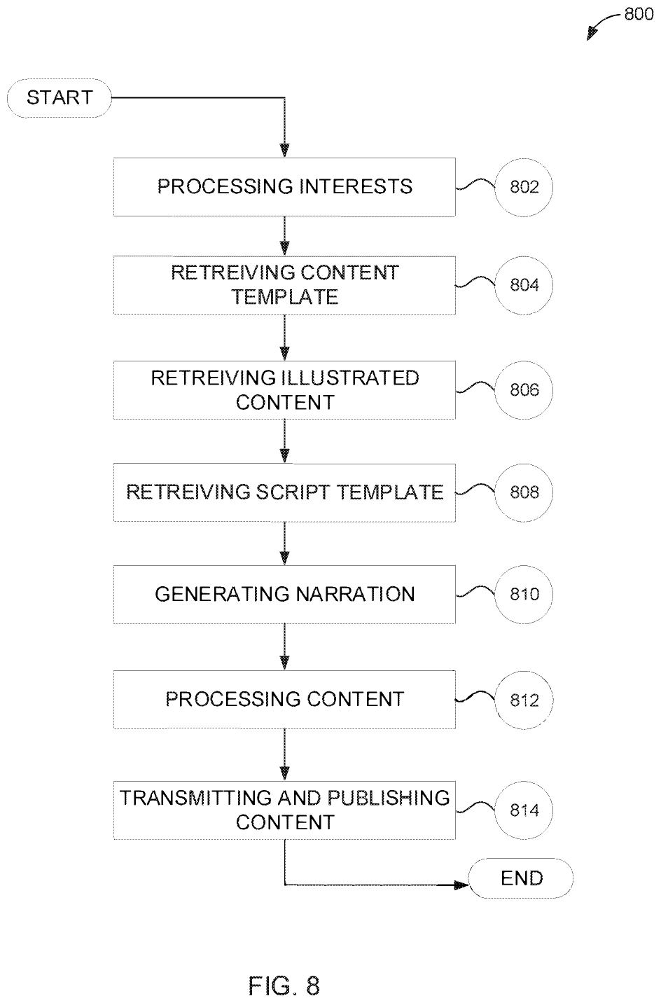

The content engine can perform a content generation process (such as the content generation process 800 shown in FIG. 8) to generate content based at least in part on one or more identified subject interests. In at least one embodiment, processing of the identified subject interests may be performed by processing one or more category identifiers associated with the subject. The generated content can include, but is not limited to, stories, animations, audio, and other digital content. In at least one embodiment, the content engine generates a digital story that includes, but is not limited to, pre-generated static or animated story frames (e.g., story “pages”), as well as pre-generated and/or dynamically generated audio, such as audio generated via a computer voice module. In one or more embodiments, because subject interests may change over time, the system may process only the most recently identified interests of a subject. For example, if the child has visited the play area on multiple occasions, the system may only process data associated with a most recent visit.

In various embodiments, the content engine may retrieve a content blacklist and/or may apply a content threshold to filter and select content for inclusion in a digital story. For example, a website (FIG. 1) may provide an application or portal that allows for input or selection of content that a user desires to exclude from digital stories (e.g., produced for the user). As another example, the website may receive, from a user account, a content threshold, or content rating. A content data store (FIG. 4) can include, for each data object or entry therein, a content rating such as, for example, a rating of G, PG and PG-13. The system can process the received content threshold or content rating such that data objects that violate the threshold or rating are excluded from story generation processes. In at least one embodiment, the content blacklist can be a set of category identifiers corresponding to types of content to be excluded from story generation processes. For example, a content blacklist for a particular subject may include a category identifier corresponding to magic-related content. The content engine can process the content blacklist and exclude, from story generation processes, content that is associated with the magic-related category identifier. In at least one embodiment, the present subject interest identification processes may also be performed to identify, and include in a content blacklist, content with which there is little predicted or observed interest, or for which there is observed avoidance. For example, the system may determine that a subject has avoided playing with dinosaur toys and entering a dinosaur themed room. The system may then update a content blacklist, associated with the subject, to include one or more category identifiers for dinosaur-related content.

In at least one embodiment, the content engine can retrieve a content preferences list to filter and select preferred content for inclusion in a digital story. The content whitelist can include one or more subject-supplied preferences. For example, a child and/or a parent thereof, via a website (FIG. 1), can update a content preferences list to include an “animal” preference. The content engine, upon retrieving the content preferences list, can configure content generation processes to include, in any digital story generated for the child, animals, and/or animal-centered storylines.

The content engine can modify pre-generated static or animated story frames to feature one or more story elements that are specifically associated with the one or more identified subject interests, or that are associated with the subject themselves. For example, the content engine can identify that a particular child enjoys playing with wizards in a castle-themed room and, accordingly, can generate content by modifying a series of pre-generated, castle-themed digital story frames to include a wizard character and a custom-generated (or, in some embodiments, subject-generated) avatar of the subject. In the same example, the content engine may modify the digital story frames to include custom-generated audio scripts and/or descriptive text that provide a narrative to and/or personalize the digital story.

At step 708, the content engine transmits generated content and a subject identifier to a communication module (for example, the communication module 121 illustrated in FIGS. 1, 3 and 5, and described herein). The communication module can process the received subject identifier to determine subject information including, but not limited to, subject contact information, such as an email address, subject and/or guardian name, and subject contact preferences. In at least one embodiment, subject information may be provided via one or more calls to an application programming interface (“API”) that provides access to a computing environment (e.g., a server, processor, and database) responsible for maintaining subject information. In some embodiments, the communication generator may generate, at a processor thereof, one or more data visualizations, metrics, and/or written summaries of received subject behavior data.

The communication module can retrieve, from a database thereof, a pre-generated template for an electronic communication. The communication module can provide the generated content, the retrieved subject information, and the template to a communication generator that populates the template with appropriate information. For example, the communication generator can process the generated content (or metadata thereof) to insert appropriate content information into the template. In the same example, the communication generator can process the subject information to insert personalized language and contact information into the template. Continuing this example, the communication generator can convert the template into an electronic communication.

In one or more embodiments, the content engine transmits a projection command, including the generated content, to one or more projection sources (FIG. 1) that are installed throughout a play environment. The one or more projection sources can process the command to obtain the generated content, and processing the command can cause the one or more projection sources to display, in real-time, the generated content (e.g., while a content-associated subject is still within the play environment). Because the present system can utilize data sources (FIG. 1) to track subject location, the system can direct projection commands to one or more projection sources determined to be located nearest to a subject (e.g., a subject from which the generated content was sourced). In at least one embodiment, the system can include one or more triggers (e.g., motion sensor events, RFID interrogations, etc.) that, upon being activated by a subject, cause the system to initiate digital content generation and display processes. Thus, the system can generate and display, to a subject, digital content while the subject is still in the play environment, and, in particular, can generate and display digital content, to a subject, in response to a physical and/or electronic trigger. As described herein, the system can leverage iterative content generation processes to generate initial, secondary, and other subsequent digital content that directs, responds to, or otherwise augments, play experiences occurring, in real-time, in the play environment.

At step 710, following population and conversion of the template into the electronic communication, the communication module (in particular, a server thereof) can transmit, via a network, the electronic communication to the appropriate subject (e.g., as provided via the processed subject information). For example, the communication module can transmit an email to a subject (or a guardian thereof) that includes the generated content, or a web link that directs the subject to the generated content (e.g., that is hosted by a server on a website, or through another similar medium). In at least one embodiment, the communication module can embed trackable content, such as read receipts, that allows the system to track and collect information related to a subject's interaction with the electronic communication. For example, links included in the electronic communication may be tracked by the system to determine whether or not a subject has accessed (e.g., clicked) the link and, if so, with what frequency.

In some embodiments, the communication engine can convert the electronic communication into an electronic report that is formatted to be viewed on a web browser (e.g., at a website, such as a website 109 as illustrated in FIG. 1 and described herein). The communication engine can transmit or upload, via a network, the electronic report to a website (in particular, to a server thereof) that processes the electronic report and hosts the electronic report therein. The electronic report can be accessed via a web address that may also be included as a link in the electronic communication.

At step 712, an engagement tracker (for example, the engagement tracker 117 illustrated in FIG. 3) collects engagement data as provided by trackable content embedded in the electronic communication. The engagement tracker can collect data including, but not limited to, information, for example, a Boolean, that indicates whether or not a subject has opened the transmitted electronic communication, a number of times a subject clicked a link included in the electronic communication, a duration for which the subject viewed the electronic communication and/or content included therein. The engagement tracker can transmit the collected engagement data and a subject identifier to an aggregated data management application that processes the engagement data and provides the processed engagement data to an aggregated data store. The aggregated data store can aggregate the processed engagement data with historical engagement therein (e.g., that is associated with the subject identifier). By collecting data on subject engagement, the system may gain insight into the effectiveness of content generated therein (e.g., high subject engagement may indicate an effectiveness of interest identification and automated content generation).

In at least one embodiment, the steps illustrated in FIG. 7 and described herein may be initiated upon detected entry of a subject into a play area. The system may detect entry of a subject into a play area through receipt of a subject registration and/or admittance signal transmitted from a system server. In at least one embodiment, the system can detect entry of a subject via an RFID location interaction (e.g., as described herein). In some embodiments, the system may await receipt of a subject exit signal (e.g., from a server) before proceeding to steps 706-712. A subject exit signal may be generated by the system following a subject checkout process and/or following detection of a particular RFID location interaction (e.g., for example, location interaction associated with a subject returning their RFID wristband to a particular room of a play area). Thus, the system may proceed to specific steps of a behavior tracking and content generation process based on whether or not a subject has entered a play area and whether or not the subject has exited the play area.

In various embodiments, the system may generate one or more aggregated metrics sourced from historical and other aggregated data. The one or more aggregated metrics can include, but are not limited to, toy rankings that identify one or more most popular toys (e.g., out of toys dispersed throughout a play area, or section thereof, or toys purchased on a website), room rankings that identify one or more most popular sections of a play area, experience rankings that identify one or more most popular experiences provided in a play area, and other rankings (for example, on/off-site activities, resources, events, etc.). Thus, the system can generate one or more aggregated metrics that may be used to further optimize content generation and/or interest prediction.

With reference to FIG. 8, shown is a content generation process 800, according to various embodiments. As an alternative, the process 800 may be viewed as depicting an example of elements of a method implemented in the networked environment 100 according to one or more embodiments.

At step 802, the system processes identified subject interests (e.g., that were determined as described herein). In at least one embodiment, a content engine retrieves predicted subject interests (e.g., generated via a machine learning process 900), which may be represented as one or more category identifiers. The content engine can utilize the one or more category identifiers as an input to a digital content creation process. For example, the content engine can retrieve one or more category identifiers associated with the subject interests, and can use the one or more category identifiers to sort through and select pre-generated content stored in a content data store (e.g., where the pre-generated content is organized based on category identifiers). The content engine may use the one or more category identifiers, throughout the digital content creation process, to identify subject matter that may be included in a final content creation.

In one embodiment, the system can identify interests for more than one subject. The system can identify friends that like to play together or friends that are connected on social media. The system can generate content for the subject to use or view together. As an example, the system may determine a first subject likes the ocean while a second subject loves monster trucks. The system may generate a story where part of the story takes place in the ocean while another part involves monster trucks. The system may also generate a story with a part of the story that involves driving monster trucks along a beach of an ocean.

At step 804, the content engine retrieves a pre-generated content template. As described herein, the content engine may include one or more databases, or the like, that store templates for digital content (in particular, digital stories). The pre-generated content template can be specifically associated with the identified subject interests, as would be established via matching category identifiers between the template and the subject interests. For example, at step 802, the content engine can identify that a particular subject is interested in oceans and sea creatures, and can select one or more category identifiers for oceans and sea creatures. In the same example, at step 804, the content engine can leverage the selected one or more category identifiers and retrieve a pre-generated content template. Continuing the same example, the pre-generated content template may provide a framework for a digital story that is centered on a main character (e.g., which may be the particular subject) exploring various ocean environments and discovering sea creatures therein. In various embodiments, the template may include a unique template identifier (in addition to the category identifier) that is used to organize the template and identify the template throughout the digital content creation process (and, thereafter, in storage).

In various embodiments, the content engine can also retrieve a decision tree (e.g., formatted as one or more data objects). The decision tree can provide, via data therein, documentation of actions and/or events that have taken place in previous digital content generated for a subject and/or in a play environment. For example, a decision tree (for a particular subject) may indicate that, in previous digital content, the particular subject was presented with an option to take a path towards a castle or take a path towards a forest. The path towards the castle and the path towards the forest may be represented, in a physical play environment, by a castle-themed room and a forest-themed room. The system, via RFID and computer vision data, may determine that, following engagement of the subject with the digital content, the subject visited the play environment and chose to play in the castle-themed room. The system can update the subject-associated decision tree to indicate that the subject chose to take the path towards the castle. In a subsequent digital content generation process, upon retrieving the subject-associated decision tree, the system can select a content template that includes the subject choosing to proceed on the path to the castle. Because the decision tree can serve as an accurate documentation of a subject's interaction and response to previously generated digital content, the decision tree can advantageously provide additional immersive aspects to subsequently generated digital content.

At step 806, the content engine retrieves illustrated content (e.g., from a content data store) and processes the retrieved content with the retrieved template to generate an illustrated template. The illustrated content can be organized using the one or more category identifiers, thereby allowing the content engine to identify and select pre-generated illustrated content that aligns with the identified subject interests. The illustrated content can include, but is not limited to, animated and/or static illustrated scenes, characters, objects, etc. The illustrated content can also include a custom avatar that serves as a digital rendering of a particular subject (e.g., the subject for whom content is being created). In one or more embodiments, the custom avatar can be an avatar that a subject designed on-site at a play area. In other embodiments, the system can recognize colors or patterns of clothing worn by the particular subject while in a play area, and generate the custom avatar with the same colors or patterns. Thus, the custom avatar can be subject-generated content 215 received from an input source 207 (each as described herein). In some embodiments, the system may include an avatar rendering module, service, engine, or the like, that can automatically generate a custom avatar (for example, by processing a photo of a subject and converting the photo into a digital illustration). The system can also generate an avatar that is different but similar to the subject. As an example, the system may identify that the subject prefers bright or dark clothing, a particular color or series of colors, a particular style of dress, or some other appearance attribute, and dress the avatar similarly. The system may determine that the subject likes a particular genre of music and put a t-shirt on the avatar with a band corresponding to that genre.

Continuing the above example, at step 806, the content engine can retrieve illustrated content that may include, but is not limited to, illustrated and/or animated scenes of various ocean environments, illustrations and/or animations of various sea creatures, an avatar of the particular subject, and tropes, plot conventions, element, or themes that relate to the ocean. In the same example, the content engine may process the retrieved illustrated content with the retrieved template to produce an illustrated digital story template. Also, in the same example, the content engine can assign frame identifiers to each version of each illustrated item (e.g., scene, character, avatar, etc.) in the digital story template. In at least one embodiment, the content engine can assign frame identifiers to illustrated content such that insertion and arrangement of illustrated content within a template can be tracked and quickly indexed.

At step 808, the content engine retrieves a script template. In particular, a language processor (of the content engine) retrieves a script template from a content data store. Within the data store, the script templates may be organized using category identifiers (as described herein) such that the content engine may quickly index and identify script templates that align with an identified subject interest. Similarly, the system can identify tropes related to the interests of the subject, and identify script templates that involve those tropes. In various embodiments, a script template may be a pre-generated and text-based narrative framework for a digital story. Script templates can include, but are not limited to, pre-generated scenes including narration and dialogue. In at least one embodiment, a script template may include all details required to draft a digital story and, to convert a script template to a script, may only require processing and population of the script template with subject information. Accordingly, at step 808, the language processor can also process a retrieved script template with a retrieved content template and subject information to populate and organize the script template such that the script template is personalized with subject details and is in a narrative arrangement that is consistent with the content template. The system can name characters in the script based on the name of the subject, the names of family members of the subject, the names of friends of the subject, the names of one or more pets of the subject, or some other known or determined name using the subject information.

Continuing the above example, at step 808, the content engine retrieves a script template for an ocean and sea creature adventure. In the same example, a language processor can process the script template with subject information and the retrieved content template (that now includes illustrated content) to produce a customized digital story script. Also, in the same example, processing may include, but is not limited to, generating one or more captions, word bubbles and/or text insertions (e.g., based on the customized script), and modifying the content template to include the one or more generated captions, word bubbles and/or text insertions. Thus, in various embodiments, the content engine can automatically process a script template to generate a customized script, and can automatically modify a content template to incorporate the customized script (e.g., in text insertions, or the like, added to one or more frames of the content template). Also, in the same example, the content engine can assign frame identifiers to one or more sections of the customized script based on how and/or where each of the one or more sections are arranged within the digital story template. In at least one embodiment, the content engine can assign frame identifiers to a script such that insertion and arrangement of one or more sections thereof within a template can be tracked and quickly indexed.

The templates can include hooks to add content from other templates in an effort to make a story arc more consistent. As an example, a first template can have foreshadowing information injected at a hook from a second template that will be used to generate a later portion of the story. Similarly, the system can inject information from the first template into a hook of the second template. As an example, if the second template includes an ending to the story, the first template can inject text related to reuniting characters from a story arc in the first template at a hook in the second template.

At step 810, the content engine generates a narration. The narration can be one or more audio renderings of a customized script (e.g., generated at step 808) and/or can include sound effects that punctuate, augment and/or accentuate the customized script. Narration generation can be performed by a computer voice module or the like, that can accept the customized script and produce, as an output, one or more audio renderings of the script (e.g., as read and/or delivered by a computer-rendered human voice). The computer voice module can include one or more databases that store sound effects and other audio files that may be inserted into the one or more audio renderings. The computer voice module, or another element of the content engine, can organize the one or more audio renderings using frame identifiers, where a frame identifier assigned to an audio rendering indicates where the audio rendering will be or is included within the digital story template. The content engine can process the one or more generated audio renderings with the digital story template to create a narrated template (e.g., that is also illustrated and text-narrated).

Continuing the above example, at step 810, the content engine can provide the custom script to a computer voice module. In the same example, the computer voice module can process the custom script and generate one or more audio renderings thereof. Also in the same example, the content engine can process the one or more audio renderings with the digital story template to create a narrated story template. In one or more embodiments, the computer voice module may include one or more configurable parameters that may dictate aspects of script processing and audio generation. For example, the one or more parameters may include, but is not limited to, a voice type (for example, a male voice, a female voice, etc.), a language type, a narration speed, and a sound effect enable/disable option.

At step 812, the content engine processes the illustrated and narrated template to render a finalized digital story. The finalized digital story can be in one or more formats including, but not limited to, a video file (e.g., .mp4, .gifv, avi, .mov, .wmv, etc.), a presentation file (e.g., .ppt, .key, .pez, etc.), and other formats suitable for providing multimedia content. The content engine can insert a subject identifier into metadata of the finalized digital story so that the system can associate the digital story with the subject. In at least one embodiment, the system stores the finalized digital story in a content database, which may organize data based on subject identifiers. Thus, the system may preserve content generated for one or more subjects. In various embodiments, in subsequent content creation processes, the system may retrieve a finalized digital story stored therein and generate a new digital story that is a sequel and/or continuation of the retrieved digital story.

Continuing the above example, at step 812, the content engine can process the illustrated and narrated template to generate a finalized digital story. In the same example, the content engine may modify metadata of the finalized digital story to include a subject identifier associated with the child. Also, in the same example, the system can store the finalized digital story in a database, or the like, where the finalized digital story is organized with other digital stories previously generated (e.g., for the child).

At step 814, the content engine transmits the finalized digital story and the subject identifier to a communication module. The communication module can process the received subject identifier to determine subject information including, but not limited to, subject contact information, such as an email address, subject and/or guardian name, and subject contact preferences. In at least one embodiment, subject information may be provided via one or more calls to an application programming interface (“API”) that provides access to a computing environment (e.g., a server, processor and database) responsible for maintaining subject information. In some embodiments, the communication generator (instead of the content engine) may generate, at a processor thereof, one or more data visualizations, metrics, and/or written summaries of received subject behavior data.

The communication module can retrieve, from a database thereof, a pre-generated template for an electronic communication. The communication module can provide the finalized digital story to a communication generator that populates the template with appropriate information. For example, the communication generator can a) process the finalized digital story to insert appropriate story information (e.g., title, description, etc.) into the template, b) process the subject information to insert personalized language and contact information into the template, and c) convert the template into an electronic communication.

Following population and conversion of the template into the electronic communication, the communication module (in particular, a server thereof) transmits, via a network, the finalized digital story to the appropriate subject (e.g., as provided via the processed subject information). For example, the communication module can transmit an email to a subject (or a guardian thereof) that includes, as an attachment, the finalized digital story. The communication module can transmit or upload, via a network, the digital story to a website (for example, the website 109 illustrated in FIG. 1 and described herein) that processes and hosts the digital story on a webpage therein. The communication module can generate (or receive from the website) a clickable link that routes to the hosting webpage. Accordingly, the communication module can insert the clickable link into the electronic communication.

In one or more embodiments, the communication engine can transmit digital content communications in real-time, while an associated subject is still within a play area. For example, a child playing in a play area can cause the system to perform one or more content generation and display processes (as described herein). Immediately following each generation of digital content, the system generates an electronic communication, including the newly generated digital content, and transmits the electronic communication, via email, to the child's parent. Thus, the system can generate and display, to a subject, digital content while the subject is still in the play environment, and, in particular, can generate and transmit digital content communications as the subject proceeds throughout the play environment (e.g., causing content generation processes). As described herein, the system can leverage iterative content generation processes to generate initial, secondary, and other subsequent digital content and content communications that imaginatively document and narrate subject play experiences occurring, in real time, in the play environment.

In at least one embodiment, the communication module can embed trackable content, such as read receipts, that allow the system to track and collect information related to a subject's interaction with the electronic communication. Data collected via trackable content can be used to determine digital content performance metrics, and to identify features of digital content with which a content expressed or did not express interest. The system can use trackable content data to identify one or more story elements (e.g., tropes, events, etc.) that appealed or did not appeal to the subject. For example, the system can use trackable content data to determine if a digital story including a surprise or twist ending appealed to an associated subject. In at least one embodiment, the system may also analyze additional subject-associated data (e.g., RFID and/or computer vision data, etc.) to improve trope and other story element identification processes. As another example, the clickable link included in the electronic communication may be tracked by the system to determine whether or not the subject has accessed (e.g., clicked) the link and, if so, with what frequency. The communication engine can include a link to share the digital story with friends or others, such as, for example, via email, text message, social media, or some other medium.

FIG. 9 shows an exemplary machine learning process 900 according to one embodiment. At step 902, the process 900 includes generating a training dataset comprising one or more parameters. The training dataset can be generated based on training data. The training data can include interaction data and known interests associated with one or more subjects. In one example, the training data includes historical interactions of a particular subject with various areas of a play environment and interactions with various toys, experiences, and other subjects therein. The training data can include one or more of, but is not limited to, categorical data, observational data, and digital interaction data. Categorical data can include data indicating whether or not a subject demonstrated a particular behavior or action, such as entering a particular area, playing with a particular toy, etc. The categorical data, or a subset thereof, can be expressed as one or more cognitive development markers. In one example, a subject that played with a musical instrument (e.g., as determined based on tracked RFID interactions) for a predetermined time period (e.g., 5 minutes, 10 minutes, etc.) is assigned a cognitive development marker for creativity and/or musical affinity. Observational data can include data that scales one or more aspects of behavior demonstrated (or not demonstrated) by the subject. For example, observational data can include a numerical value on a scale of 1-10 that represents a level of socialization that the subject demonstrated with other subjects in a particular play area (e.g., 1 representing little or no socialization and 10 representing virtually continuous socialization). The digital interaction data can include tracked engagement of a subject with various digital content, such as electronic communications, offers, animations, games, etc. Any data described herein that is collected by or provided to the system may be included in the training data. The training data may be pseudo-anonymized or fully anonymized and, in some embodiments, may be processed to isolate or reduce a prevalence of potential bias factors, such as age, sex, gender, and etc.

The training data can be selected to comprise data for a particular time period, such as, for example, one day, one month, one year, and etc., or for a predetermined number of visits to the play environment, such as, for example, one visit, five visits, ten visits, and etc. In some embodiments, the training data is selected based on one or more criteria of a subject for which interests are to be predicted. In one example, the subject is a seven-year old male and the training data is sourced from one or more other seven-year old males (or, in some embodiments, the same seven-year old male). In some embodiments, a subset of the information included in the training data can be predetermined based on heuristics and/or manual input by a user.

The training data can be organized into a plurality of parameters. For example, a time series record of tracked interactions in which a subject played with a particular toy can be expressed as a percentage of the subject's total time spent in a play environment. As another example, a subject can be assigned a score from 1-5 that corresponds to a number of play areas within a play environment that the subject visited in which the subject interacted with at least one play element, such as a toy, for a predetermined time period (e.g., a value of 5 indicating that the subject visited 5 play areas and interacted with a toy or experience in each play area). In the same example, the particular play areas in which the subject demonstrated the greatest amount of interaction can be mapped to one or more cognitive development parameters, such as working memory, pattern recognition, etc. Non-limiting examples of scaled and categorical values for cognitive development markers and other data are included in Table 1. As shown, a subset of interaction data can be scale-based and a second subset can be categorical, for example the second subset can be Boolean-value based (e.g., in which a value of 1 corresponds to YES and a value of 0 corresponds to NO).

TABLE 1
Exemplary Interaction Data

| Development | | Loca- | Loca- | Loca- | Loca- | Loca- |
|---|---|---|---|---|---|---|
| Category | Sub-category | tion 1 | tion 2 | tion 3 | tion 4 | tion 5 |
| Cognitive | Sustained | 8 | 7 | 1 | 10 | 8 |
| Development | Attention Span | | | | | |
| Cognitive | Questioning | 4 | 9 | 5 | 2 | 0 |
| Development | Skills | | | | | |
| Cognitive | Working | 4 | 9 | 9 | 5 | 3 |
| Development | Memory | | | | | |
| Cognitive | Pattern | 10 | 3 | 0 | 10 | 9 |
| Development | Recognition | | | | | |
| Cognitive | Category | N/A | YES | NO | NO | YES |
| Development | Formation | | | | | |
| Cognitive | Problem | 6 | 0 | 5 | 1 | 10 |
| Development | Solving | | | | | |
| Cognitive | Creativity and | 9 | 9 | 1 | 4 | 8 |
| Development | Imagination | | | | | |
| Physical | Fine Motor | 10 | 10 | 6 | N/A | 9 |
| Development | Skills | | | | | |
| Physical | Gross Motor | 2 | 0 | 8 | 2 | 8 |
| Development | Skills | | | | | |
| Physical | Sensory | 0 | 5 | 2 | 2 | 10 |
| Development | Processing | | | | | |
| Social | Self- | YES | NO | YES | YES | YES |
| Emotional | Awareness | | | | | |
| Development | | | | | | |
| Social | Self- | 2 | 4 | 4 | 4 | 4 |
| Emotional | Management | | | | | |
| Development | | | | | | |
| Social | Social | 1 | 8 | 8 | 5 | 5 |
| Emotional | Awareness | | | | | |
| Development | | | | | | |
| Social | Decision | 0 | 5 | 2 | 7 | 10 |
| Emotional | Making | | | | | |
| Development | | | | | | |
| Social | Reflectiveness | 10 | 0 | 1 | 1 | 0 |
| Emotional | | | | | | |
| Development | | | | | | |
| Social | Curiosity | 0 | 10 | 2 | 10 | 2 |
| Emotional | | | | | | |
| Development | | | | | | |
| Social | Relationship | 3 | 8 | 6 | 3 | 1 |
| Emotional | Skills | | | | | |
| Development | | | | | | |
| Language | Speaking and | 7 | 0 | 2 | 1 | 0 |
| Development | Listening Skills | | | | | |
| Language | Reading and | 9 | 4 | 5 | 3 | 3 |
| Development | Writing | | | | | |
| | Foundations | | | | | |

Each location of a play environment can be associated with specific play types that may be used to predict a subject's interests. Non limiting examples of play types include, but are not limited to, creation (e.g., expressing one's self through creative activities), imagination (e.g., engaging in stories and environments through role of narrative play), achievement (e.g. goal-oriented activities activated by collaboration or competition), exploration (e.g., learning and discovery of the surrounding environment), and construction (e.g., combining existing elements to create a new element). In at least one embodiment, play types can be associated with various categories of development including, but not limited to, emotional (e.g., processing and managing emotional responses in various situations), social (e.g., navigating positive and negative interactions with others), physical (e.g., coordination and agility using fine and gross motor skills), cognitive (e.g., formation and understanding of concepts and systems), and language (e.g., communication of feelings and ideas through writing and speech).

In various embodiments, each area, activity, toy, interaction and/or experience of a play environment and/or an external environment (e.g., including digital and physical environments) is assigned a floating point value in each category. The floating point values for the categories can be used to cluster similar areas, activities, toys, and etc. for the purposes of generating content based on past behavior of a subject, as well as behavior from similar subjects. Data associated with subjects can be used to identify patterns of interests and subject behaviors. The data associated with subjects can include, for example, age, normal attendance (e.g., frequency of visit to a play environment or play area), attendance at special events and programs, survey responses (e.g., self-reported interests, behavior, feedback on previous predicted interests, content, recommendations, etc.), purchase history, interaction data (e.g., such as tracked RFID interactions), and recorded observations, for example, from staff members in a play environment.

The training dataset can be automatically generated based on data from subjects that positively responded to previous content provided thereto and which were generated based on predictions of subject interests. In some embodiments, one or more elements of the training dataset can be included based on input from a subject matter expert or other user. A plurality of training datasets can be generated, for example, that correspond to various types of subjects. For example, a training dataset can be generated for a particular age band, cognitive development level, or pattern of behavior. At step 904, the process 900 includes determining weight values for each parameter of the training dataset. Determining the weight values can include, for example, performing a regression analysis on the training dataset and known interests to compute a predictive power of each of the plurality of parameters of the training dataset. In some embodiments, local topic modeling and clustering processes are performed to identify parameters that are predictive for particular interests. For example, based on clustering techniques, categorical data associated with a music room (e.g., number of visits, duration of visits, interaction with an instrument, etc.) and particular observational data (e.g., asking questions about an instrument, playing scales, etc.) are determined to be predictive for musical interest. Parameters demonstrating greater predictive power can correspond to greater weight values being determined (e.g., as compared to those demonstrated by less predictive parameters). In some embodiments, one or more weight values can be predetermined based on heuristics and/or manual input by a user. In at least one embodiment, a weight for a categorical parameter can be generated based on an observational score attributed to the categorical parameter. For example, for a categorical parameter for playing with a toy, a weight value can be computed based on an observation score quantifying a level of creativity demonstrated by a subject that interacted with the toy.

At step 906, the process 900 includes assigning a parameter weight to each parameter of the training dataset and generating a machine learning model based on the weighted parameters (e.g., the parameter weight being based on the corresponding weight value determined at step 904). Assigning the parameter weight can include scaling and/or multiplying the floating point or other value of each parameter by the weight value, the weight value at least partially determining the contribution of each parameter to a prediction generated by a machine learning model. The machine learning model can include, for example, a neural network, such as a perceptron trained to classify a subject into one of a plurality of play profiles based on the subject's tracked behavior, wherein the play profile corresponds to one or more particular interests and is associated with particular topics, locations, narratives, toys, experiences, and activities that may be included in content provided to the subject.

In some embodiments, the machine learning model is a supervised learning model in which the training dataset for training the model includes labels for known outputs (e.g., predetermined interests for each subject in the training dataset). In at least one embodiment, the machine learning model is an unsupervised learning model in which the training dataset may exclude labels indicating an expected or correct output.

At step 908, the process 900 includes generating, using the training dataset, an output from the machine learning model and analyzing the output. The output can include, for example, one or more predicted interests. Analyzing the output can include, for example, computing an accuracy metric between the one or more predicted interests and one or more known interests that correspond to each suspect. Accuracy can be computed based on calculating a similarity or dissimilarity score between a predicted and a known interest. In one example, a known interest is an interest in horses and a corresponding accuracy metric for a predicted interest in animals is greater than an accuracy metric for a predicted interest in sports (e.g., which may be less related to the known interest).

At step 910, the process 900 includes determining that the output from the machine learning model satisfies one or more thresholds. The threshold can be, for example, an accuracy level between the predicted interests and the known interests of the training dataset. In response to determining that the output satisfies the threshold, the process 900 can proceed to step 912. In response to determining that the output does not satisfy the threshold, the process 900 can return to step 904 or 906 in which parameter values and other properties of the machine learning model can be optimized. In one or more embodiments, the process 900 may perform a validation technique, such as K-folds cross-validation to train the machine learning model using a plurality of training datasets to improve the performance of the model.

At step 912, the process 900 includes predicting one or more interests using the trained machine learning model. Interaction data for a particular subject can be provided as an input to the trained machine learning model and the model can be executed to generate output comprising one or more predicted interests based on the input. The predicted interests can be scored, for example, based on an estimated level of interest. In some embodiments, a second machine learning model can be trained to generate content based on the predicted interests. In at least one embodiment, content corresponding to potential predicted interests may be predefined and maintained in a database (e.g., as templates), and may be retrieved based on the output of the model.

The output can include a ranking of the parameters that contributed the most to the predicted interest. In one example, an output can include a predicted interest in outdoor animal-based activities and can further include a ranking of parameters including play with a particular animal toy, level of participation in and attendance at animal-related programming, and scaled metrics for creation, imagination, and exploration demonstrated by the corresponding subject in an animal-related play area or activity. The output, input, and model version can be stored in a database and can be associated with the subject to enable analysis and optimization, for example, in response to determining that the predicted interests for the subject were not accurate or that the subject did not engage with content provided thereto based on the predicted interests.

In at least one embodiment, the system can perform content generation processes on a serialized basis. In other words, the system, in generating new content for a subject, can retrieve previously generated content and continue a narrative or other element established in the previously generated content. The system can continue the previously established narrative or other element in its entirety (e.g., generating a sequel content) or may integrate portions of the previously established narrative or other element into the new content. In an exemplary scenario, a child makes a first visit to a play area and, during the first visit, plays with a fire truck toy in a city-themed room. In the same scenario, following the first visit, the system processes tracked behavior of the first child, determines that the child is interested in fire trucks and cities, and automatically generates a digital story featuring a fire truck extinguishing a fire. Continuing the same scenario, during a second visit, the child again plays with the fire truck toy in the city room. In the same scenario, following the second visit, the system processes tracked behavior of the first child, determines that the child is interested in fire trucks and cities, retrieves the previously generated digital story (or a template thereof), and generates a sequel digital story featuring additional events related to extinguishing fires via a firetruck. By leveraging previously generated content to generate new content, the system may generate evolving and more stimulating content that reflects and is directly influenced by activities of a subject over repeated visits to a play area, or the like.

In at least one embodiment, the system may modify or configure elements of a physical play environment to reflect events, actions, or other elements present in generated digital content. For example, the system may present a subject with digital content that includes a forest scene set during winter. The forest scene may be sourced from the subject's play activity in a forest-themed room during a previous visit to a play environment. Subsequently, the system can detect (e.g., via RFID, computer vision, etc.) that the subject, during a subsequent visit has re-entered the forest-themed room. Upon detecting the entry, the system can retrieve and/or use the previously generated digital content as an input to a room control system that a) lowers the temperature of the room and b) commands one or more projection sources (FIG. 1) to display animations of snow falling throughout a winter forest scene.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media, which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid-state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general-purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer- readable medium. Thus, any such connection is properly termed and considered a computer-readable medium. Combinations of the above should also be included within the scope of computer-readable media. Computer-executable instructions comprise, for example, instructions and data which cause a general-purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed systems may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems will be readily discemible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

Aspects, features, and benefits of the claimed devices and methods for using the same will become apparent from the information disclosed in the exhibits and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the devices and methods for using the same to the precise forms disclosed. Many modifications and variations are possible in light of the above teaching.

The embodiments were chosen and described in order to explain the principles of the systems and processes and their practical application so as to enable others skilled in the art to utilize the systems and processes and various embodiments and with various modifications as are suited to the particular use contemplated. Alternative embodiments will become apparent to those skilled in the art to which the systems and processes pertain without departing from their spirit and scope. Accordingly, the scope of the systems and methods is defined by the appended claims rather than the foregoing description and the exemplary embodiments described therein.

1-20. (canceled)

21. A method for training at least one machine learning model for automated composition generation, comprising:
populating a user profile based at least in part on user input obtained from a client device;
generating engagement data based at least in part on at least one tracked interaction between the client device and an electronic communication comprising at least one digital composition;
predicting, via a machine learning model, at least one interest of a user based at least in part on the engagement data and the user profile associated with a user of the client device;
generating a second digital composition based at least in part on the at least one interest of the user; and
causing rendering of the second digital composition on a display of the client device.

22. The method of claim 21, further comprising:
obtaining a video stream from at least one computer vision source, the video stream capturing at least one behavior of the user in a physical environment; and
predicting, via the machine learning model, the at least one interest of the user further based at least in part on the video stream.

23. The method of claim 21, further comprising:
obtaining location data indicative of movement of the user into a subset of a physical environment; and
predicting, via the machine learning model, the at least one interest of the user based at least in part on the location data.

24. The method of claim 21, wherein:
the user input comprises at least one character string configured to describe at least one observed behavior of the user in a physical environment.

25. The method of claim 24, wherein:
the second digital composition comprises a digital story comprising at least one visual element based on the at least one observed behavior of the user.

26. The method of claim 21, wherein:
the user input comprises at least one known interest of the user.

27. The method of claim 21, wherein:
the user input comprises at least one character string configured to describe the user in accordance with at least one of a plurality of cognitive development markers.

28. The method of claim 27, wherein:
the plurality of cognitive development markers comprise attention span, questioning skills, working memory, pattern recognition, category formation, problem solving, and creativity.

29. The method of claim 21, further comprising:
generating second engagement data based at least in part on an additional tracked interaction between the client device and the second digital composition:
generating a training dataset based at least in part on the second engagement data, the second digital composition, and the at least one interest of the user; and
training the machine learning model based at least in part on the training dataset.

30. The method of claim 21, wherein:
the at least one digital composition comprises a digital story comprising at least one visual element and at least one audio element; and
the second digital composition comprises a continuation of the digital story comprising at least a second visual element and at least a second audio element based at least in part on the at least one interest of the user.

31. The method of claim 21, further comprising:
obtaining a video stream from at least one computer vision source, the video stream capturing at least one behavior of the user and at least one behavior of a second user in a physical environment;
determining an association between the user and the second user based at least in part on the respective behaviors; and
generating respective digital avatars of the user and the second user based at least in part on the video stream, wherein:
the second digital composition comprises at least one visual element comprising respective digital avatars of the user and the second user.

32. The method of claim 21, wherein:
the user input comprises feedback associated with at least one survey response.

33. The method of claim 32, wherein:
the at least one survey response is associated with a second user of the client device.

34. A system for training a least one machine learning model for automated composition generation, the system comprising at least one computing device configured to:
populate a user profile based at least in part on user input obtained from a client device;
generate engagement data based at least in part on at least one tracked interaction between the client device and an electronic communication comprising at least one digital composition;
predict, via a machine learning model, at least one interest of a user based at least in part on the engagement data and the user profile associated with a user of the client device;
generate a second digital composition based at least in part on the at least one interest of the user; and
cause rendering of the second digital composition on a display of the client device.

35. The system of claim 34, further comprising:
at least one computer vision source, wherein the at least one computing device is further configured to:
obtain a video stream from at least one computer vision source, the video stream capturing at least one behavior of the user in a physical environment; and
predict, via the machine learning model, the at least one interest of the user further based at least in part on the video stream.

36. The system of claim 34, wherein:
the user input comprises at least one character string configured to describe at least one observed behavior of the user in a physical environment.

37. The system of claim 36, wherein:
the second digital composition comprises a digital story comprising at least one visual element based on the at least one observed behavior of the user.

38. The system of claim 34, wherein:
the user input comprises at least one character string configured to describe the user in accordance with at least one of a plurality of cognitive development markers.

39. The system of claim 38, wherein:
the plurality of cognitive development markers comprise attention span, questioning skills, working memory, pattern recognition, category formation, problem solving, and creativity.

40. A non-transitory computer-readable medium for training at least one computer-implemented model having stored thereon computer program code that, when executed on at least one computing device, causes the at least one computing device to:
populate a user profile based at least in part on user input obtained from a client device;
generate engagement data based at least in part on at least one tracked interaction between the client device and an electronic communication comprising at least one digital composition;
predict, via a machine learning model, at least one interest of a user based at least in part on the engagement data and the user profile associated with a user of the client device;
generate a second digital composition based at least in part on the at least one interest of the user; and
cause rendering of the second digital composition on a display of the client device.
